(19) United States
(12) Patent Application Publication
(10) Pub. No.: US 2015/0338955 A1
(43) Pub. Date: Nov. 26, 2015

(54) TOUCH PANEL CONTROLLER AND ELECTRONIC DEVICE USING SAME

(71) Applicant: SHARP KABUSHIKI KAISHA, Osaka-shi, Osaka (JP)

(72) Inventor: Mutsumi HAMAGUCHI, Osaka-shi (JP)

(73) Assignee: SHARP KABUSHIKI KAISHA, Osaka-shi, Osaka (JP)

(21) Appl. No.: 14/646,446

(22) PCT Filed: Nov. 19, 2013
(86) PCT No.: PCT/JP2013/081159

§ 371 Date: May 21, 2015

(30) Foreign Application Priority Data
Nov. 30, 2012 (JP) 2012-263806

(51) Int. Cl. G06F 3/044; G06F 3/041

(52) U.S. Cl. CPC G06F 3/044; G06F 3/0416

(57) ABSTRACT

The present invention includes a driver (5a) for driving, at a first timing, signal lines (HL1-HLM) with the same driving voltage so that signal lines (VL1-VLM) output first linear sum signals based on electric charges of capacitors, respectively, and driving, at a second timing which is driving timing subsequent to the first timing, the signal lines (VL1-VLM) in accordance with a code sequence so that the first signal lines output second linear sum signals, respectively.

### TECHNICAL FIELD

The present invention relates to (i) a touch panel controller which calculates a distribution of capacitances of a plurality of capacitors provided at respective intersections where a plurality of first signal lines and a plurality of second signal lines intersect with each other, and (ii) an electronic device using the touch panel controller.

### BACKGROUND ART

Patent Literature 1 discloses a touch panel controller which calculates a distribution of capacitances of a plurality of capacitors provided at respective intersections where a plurality of X-electrodes (first signal lines) and a plurality of Y-electrodes (second signal lines) intersect with each other.

The touch panel controller is configured such that a control circuit controls a switch, and during a period A, an electrode driving circuit supplies a voltage to each of the Y-electrodes and a current detection circuit detects currents flowing in all the X-electrodes, and during a period B, the electrode driving circuit supplies a voltage to each of the X-electrodes and the current detection circuit detects currents flowing in all the Y-electrodes.

### CITATION LIST

### Patent Literatures

### Patent Literature 1

Japanese Patent Application Publication, Tokukai, No. 2010-3048 (published on Jan. 7, 2010)

### SUMMARY OF INVENTION

### Technical Problem

However, the aforementioned conventional art has a problem that there are generated noises resulting from floating nodes which are capacitive-coupled with the X-electrodes (first signal lines) and the Y-electrodes (second signal lines) via parasitic capacitors.

An object of the present invention is to provide (i) a touch panel controller capable of reducing noises resulting from the floating nodes, and (ii) an electronic device using the touch panel controller.

### Solution to Problem

In order to solve the foregoing problem, a touch panel controller in accordance with one aspect of the present invention is a touch panel controller which calculates distribution of capacitances of a plurality of capacitors provided at respective intersections where a plurality of first signal lines and a plurality of second signal lines intersect with each other, the plurality of first signal lines being capacitive-coupled with first floating nodes via first parasitic capacitors, respectively, and the plurality of second signal lines being capacitive-coupled with second floating nodes via second parasitic capacitors, respectively, the touch panel controller including: a driving section for driving, at a first timing, the plurality of first signal lines with a same driving voltage so that the plurality of second signal lines output first linear sum signals based on electric charges of the plurality of capacitors, respectively; and an amplifier for amplifying, at the first timing, the first linear sum signals respectively outputted from the plurality of second signal lines, the driving section driving, at a second timing which is a driving timing subsequent to the first timing, the plurality of second signal lines in accordance with a code sequence so that the plurality of first signal lines output second linear sum signals based on electric charges of the plurality of capacitors, respectively, the amplifier amplifying, at the second timing, the second linear sum signals respectively outputted from the plurality of first signal lines, the amplifier being a differential amplifier corresponding to adjacent ones of the plurality of first signal lines and adjacent ones of the plurality of second signal lines, and the touch panel controller further comprising a capacitance distribution calculation section for calculating the distribution of capacitances of the plurality of capacitors in accordance with the second linear sum signals and the code sequence.

Another touch panel controller in accordance with one aspect of the present invention is a touch panel controller which calculates distribution of capacitances of a plurality of capacitors provided at respective intersections where a plurality of first signal lines and a plurality of second signal lines intersect with each other, the touch panel controller including: a driving section for driving, at a first timing, the plurality of first signal lines in accordance with a code sequence so that the plurality of second signal lines output first linear sum signals based on electric charges of the plurality of capacitors, respectively; and an amplifier for amplifying, at the first timing, the first linear sum signals respectively outputted from the plurality of second signal lines, the driving section driving, at a second timing, the plurality of second signal lines in accordance with the code sequence so that the plurality of first signal lines output second linear sum signals based on electric charges of the plurality of capacitors, respectively, the amplifier amplifying, at the second timing, the second linear sum signals respectively outputted from the plurality of first signal lines, the plurality of second signal lines being capacitive-coupled with floating nodes via parasitic capacitors, and the driving section driving the plurality of first signal lines so that polarities of the first linear sum signals are inverted in time sequence.

Still another touch panel controller in accordance with one aspect of the present invention is a touch panel controller which calculates distribution of capacitances of a plurality of capacitors provided at respective intersections where a plurality of first signal lines and a plurality of second signal lines intersect with each other, the plurality of first signal lines being capacitive-coupled with first floating nodes via first parasitic capacitors, respectively, and the plurality of second signal lines being capacitive-coupled with second floating nodes via second parasitic capacitors, respectively, the touch panel controller having a calibration mode in which no touch input to any of the plurality of capacitors is made and a scan mode in which a touch input to at least one of the plurality of capacitors is detected, the touch panel controller including: a driving section for (i) driving, at a calibration mode first timing, the plurality of first signal lines in accordance with a code sequence so that the plurality of second signal lines output calibration mode first linear sum signals based on electric charges of the plurality of capacitors, respectively, and (ii) driving, at a calibration mode second timing, the plurality of second signal lines in accordance with the code sequence so that the plurality of first signal lines output calibration mode second linear sum signals based on electric charges of the plurality of capacitors, respectively; an amplifier for (i) amplifying, at the calibration mode first timing, the calibration mode first linear sum signals respectively outputted from the plurality of second signal lines and (ii) amplifying, at the calibration mode second timing, the calibration mode second linear sum signals respectively outputted from the plurality of first signal lines; and a capacitance distribution calculation section for calculating a calibration mode capacitance distribution in accordance with the calibration mode first linear sum signals, the calibration mode second linear sum signals, and the code sequence, the driving section driving, at a scan mode first timing, the plurality of first signal lines in accordance with the code sequence so that the plurality of second signal lines output scan mode first linear sum signals based on electric charges of the plurality of capacitors, respectively, and driving, at a scan mode second timing, the plurality of second signal lines in accordance with the code sequence so that the plurality of first signal lines output scan mode second linear sum signals based on electric charges of the plurality of capacitors, respectively, the amplifier amplifying, at the scan mode first timing, the scan mode first linear sum signals respectively outputted from the plurality of second signal lines, and amplifying, at the scan mode second timing, the scan mode second linear sum signals respectively outputted from the plurality of first signal lines, the capacitance distribution calculation section calculating a scan mode capacitance distribution in accordance with the scan mode first linear sum signals, the scan mode second linear sum signals, and the code sequence, and calculating the distribution of capacitances of the plurality of capacitors by subtracting the calibration mode capacitance distribution from the scan mode capacitance distribution, and operation timing in the calibration mode being equal to operation timing in the scan mode.

Still another touch panel controller in accordance with one aspect of the present invention is a touch panel controller which calculates distribution of capacitances of a plurality of capacitors provided at respective intersections where a plurality of first signal lines and a plurality of second signal lines intersect with each other, the touch panel controller including: a driving section for driving, at a first timing, the plurality of first signal lines in accordance with a code sequence so that the plurality of second signal lines output first linear sum signals based on electric charges of the plurality of capacitors, respectively; and an amplifier for amplifying, at the first timing, the first linear sum signals respectively outputted from the plurality of second signal lines, the driving section driving, at a second timing, the plurality of second signal lines in accordance with the code sequence so that the plurality of first signal lines output second linear sum signals based on electric charges of the plurality of capacitors, respectively, the amplifier amplifying, at the second timing, the second linear sum signals respectively outputted from the plurality of first signal lines, the second timing being a time after voltages of floating nodes have been stabilized, the floating nodes being capacitive-coupled with the plurality of first signal lines via parasitic capacitors, respectively.

An electronic device in accordance with one aspect of the present invention comprises a touch panel system including the touch panel controller in accordance with one aspect of the present invention.

### Advantageous Effects of Invention

With one aspect of the present invention, the plurality of first signal lines output linear sum signals at driving timing immediately after the plurality of first signal lines have been driven with the same voltage, and distribution of capacitances is calculated in accordance with the linear sum signals. Since the plurality of first signal lines immediately before outputting the linear sum signals are driven with the same drive voltage, voltages of two sense lines supplied to the differential amplifier show the same behaviors, and so voltages of corresponding two floating nodes show the same behaviors. Accordingly, amplification made by the differential amplifier cancels noises resulting from the voltages of the floating nodes. This yields the effect of providing a touch panel controller capable of reducing noises resulting from floating nodes.

### BRIEF DESCRIPTION OF DRAWINGS

FIG. 1 is a block diagram illustrating a configuration of a touch panel system which is a premise of the present invention.

FIG. 2 is a schematic view illustrating a configuration of a touch panel provided in the touch panel system.

FIG. 3 is a circuit diagram illustrating a configuration of a connection switching circuit between (a) signal lines connected to the touch panel and (b) drive lines connected to a driver and sense lines connected to a sense amplifier.

FIG. 4 is a circuit diagram illustrating a configuration of a multiplexer provided in a capacitance distribution detection circuit of the touch panel system.

(a) and (b) of FIG. 5 are schematic views each illustrating an operation method of the touch panel system.

FIG. 6 is a schematic view illustrating an operation method of the touch panel system.

(a) and (b) of FIG. 7 are schematic views each illustrating another operation method of the touch panel system.

FIG. 8 is a circuit diagram illustrating floating nodes which are capacitive-coupled with sense lines of the touch panel system via parasitic capacitors.

(a) of FIG. 9 is a waveform chart showing a control signal of the touch panel system, (b) of FIG. 9 is a waveform chart showing voltages of the floating nodes, of FIG. 9 is a waveform chart showing voltages of signal lines, and (d) of FIG. 9 is a waveform chart showing an output waveform of a differential amplifier connected to the signal lines.

FIG. 10 is a block diagram illustrating a configuration of a touch panel system in accordance with First Embodiment.

(a) of FIG. 11 is a waveform chart showing a control signal of the touch panel system, (b) of FIG. 11 is a waveform chart showing voltages of floating nodes of the touch panel system, (c) of FIG. 11 is a waveform chart showing voltages of sense lines of the touch panel system, and (d) of FIG. 11 is a waveform chart showing an output waveform of a differential amplifier connected to the sense lines.

FIG. 12 is a block diagram illustrating a configuration of a touch panel system in accordance with Second Embodiment.

(a) and (b) of FIG. 13 are views each illustrating a method of inversely driving an electrostatic capacitor in the touch panel system.

FIG. 14 is a block diagram illustrating a configuration of a touch panel system in accordance with Third Embodiment.

(a), (b), and (c) of FIG. 15 are views each illustrating a unit of driving performed on capacitors in the touch panel system.

FIG. 16 is a block diagram illustrating a configuration of a touch panel system in accordance with Fourth Embodiment.

FIG. 17 is a block diagram illustrating a configuration of an electronic device in accordance with Fifth Embodiment.

### DESCRIPTION OF EMBODIMENTS

Premise of the Present Invention

The inventors of the present invention have proposed a touch panel system which drives drive lines in parallel, in which in order to remove a noise resulting from a touch on a panel by a human hand, thumb, finger etc. influenced by an electromagnetic noise, a plurality of first signal lines and a plurality of second signal lines, at intersections of which a plurality of capacitors are provided, are driven alternately (Japanese Patent Application No. 2011-142164, filed on Jun. 27, 2011).

First, as a premise of the present invention, the following description will discuss the aforementioned configuration. “Phantom noise” as used herein indicates an error signal which is generated in such a manner that an electromagnetic noise which a human body has received from an ambiance is supplied to a touch panel via a hand, thumb, finger etc. and is superimposed on a signal flowing in a sense line touched by the hand, thumb, finger etc.

Configuration of Touch Panel System 50

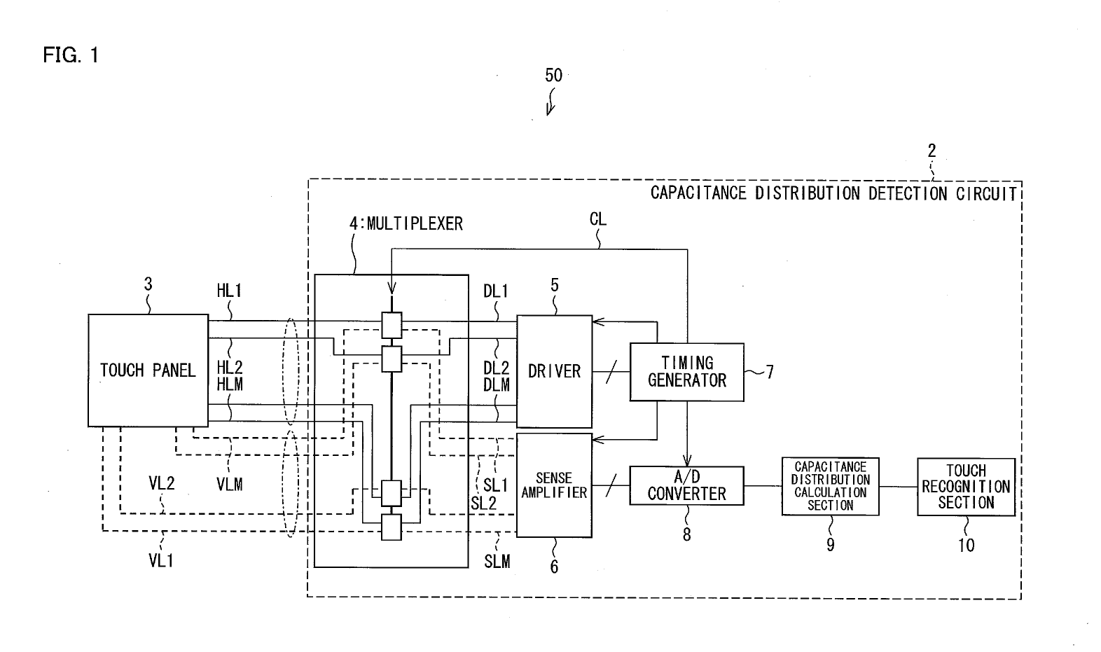

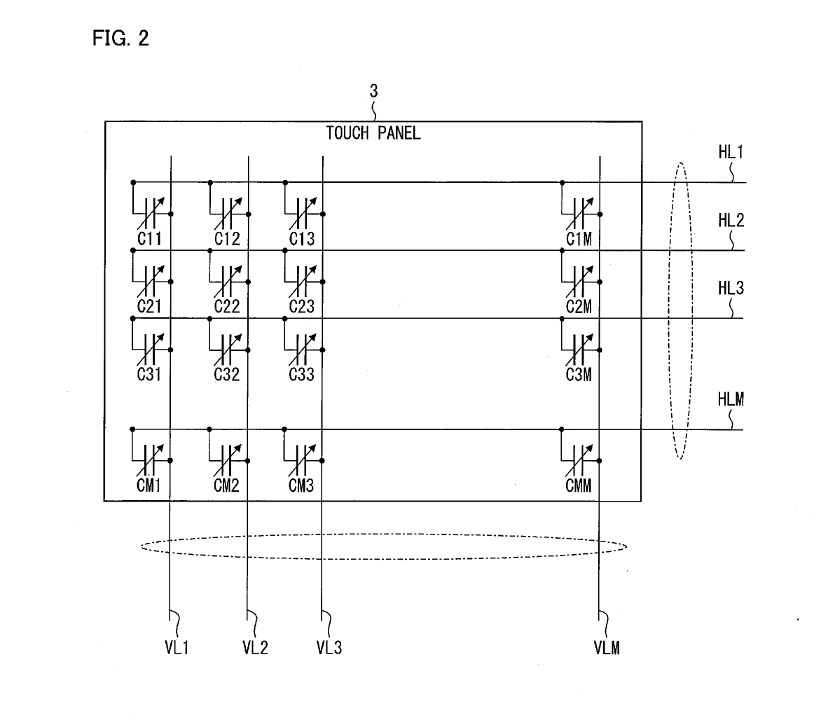

FIG. 1 is a block diagram illustrating a configuration of a touch panel system 50 in accordance with Embodiment 1. FIG. 2 is a schematic view illustrating a configuration of a touch panel 3 provided in the touch panel system 50.

The touch panel system 50 includes a touch panel 3 and a capacitance distribution detection circuit 2. The touch panel 3 includes signal lines HL1 to HLM (first signal lines) arranged parallel to each other in a horizontal direction, signal lines VL1 to VLM (second signal lines) arranged parallel to each other in a vertical direction, and capacitors C11 to CMM provided at respective intersections where the signal lines HL1 to HLM and the signal lines VL1 to VLM intersect with each other. It is preferable that the touch panel 3 is so wide as to allow a hand holding a stylus to be placed on the touch panel 3. Alternatively, the touch panel 3 may be of a size that is usable for a smart phone.

The capacitance distribution detection circuit 2 includes a driver 5. The driver 5 applies a voltage on drive lines DL1 to DLM in accordance with a code sequence. The capacitance distribution detection circuit 2 includes a sense amplifier 6. The sense amplifier 6 reads out, via the sense lines SL1 to SLM, a linear sum of electric charges that correspond to the capacitors, and supplies the linear sum to an A/D converter 8.

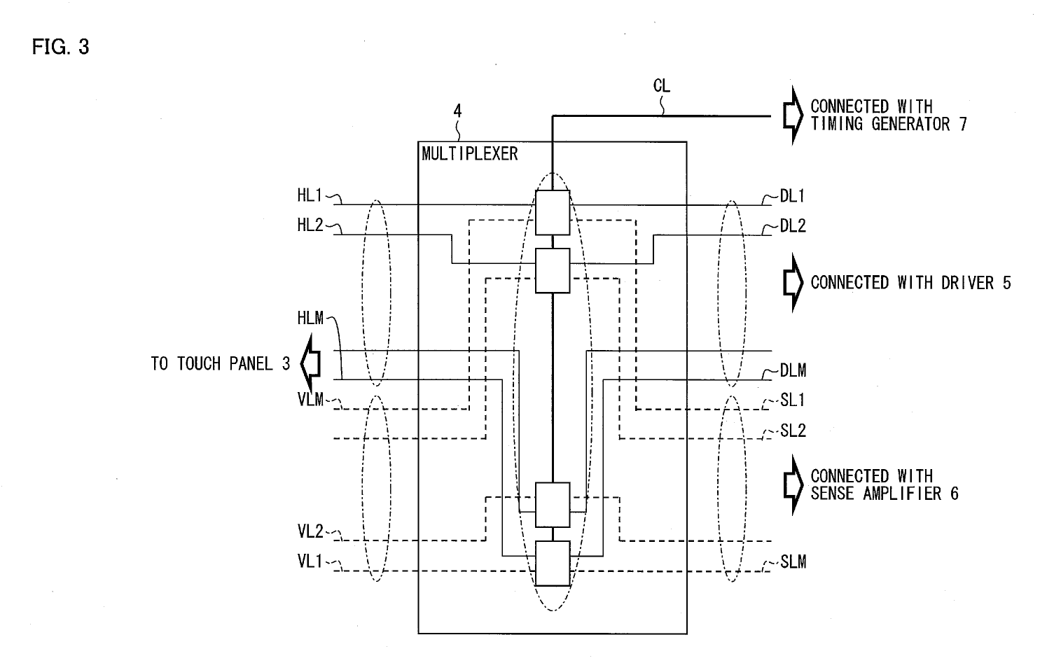

The capacitance distribution detection circuit 2 includes a multiplexer 4. FIG. 3 is a circuit diagram illustrating a configuration of a connection switching circuit between (a) the signal lines HL1 to HLM and VL1 to VLM connected to the touch panel 3, and (b) the drive lines DL1 to DLM connected to the driver 5 and the sense lines SL1 to SLM connected to the sense amplifier 6.

The multiplexer 4 causes a switchover between (a) a first connection state in which the signal lines HL1 to HLM are connected to the drive lines DL1 to DLM of the driver 5 and the signal lines VL1 to VLM are connected to the sense lines SL1 to SLM of the sense amplifier 6 and (b) a second connection state in which the signal lines HL1 to HLM are connected to the sense lines SL1 to SLM of the sense amplifier 6 and the signal lines VL1 to VLM are connected to the drive lines DL1 to DLM of the driver 5.

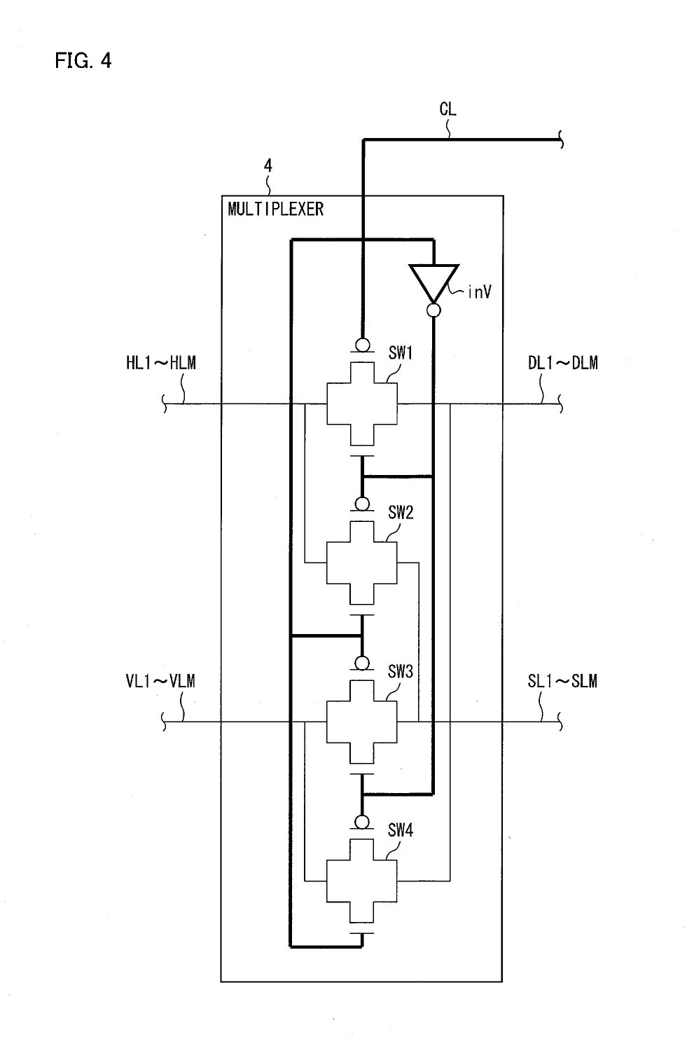

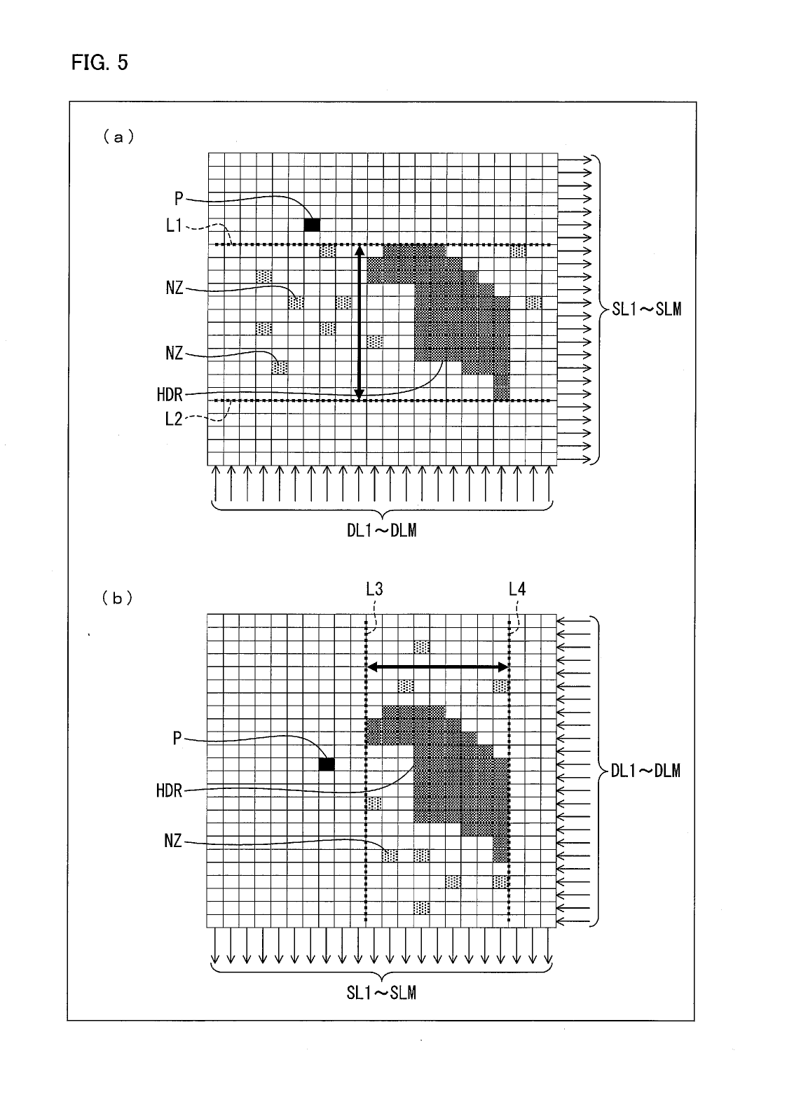

FIG. 4 is a circuit diagram illustrating a configuration of the multiplexer 4 provided in the capacitance distribution detection circuit 2 of the touch panel system 50. The multiplexer 4 includes four CMOS switches SW1 to SW4, which are connected in series. A control line CL from the timing generator 7 is connected to a gate of a PMOS of the CMOS switch SW1, a gate of an NMOS of the CMOS switch SW2, a gate of a PMOS of the CMOS switch SW3, a gate of an NMOS of the CMOS switch SW4, and an input of an inverter inv. An output of the inverter inv is connected to a gate of an NMOS of the CMOS switch SW1, a gate of a PMOS of the CMOS switch SW2, a gate of an NMOS of the CMOS switch SW3, and a gate of a PMOS of the CMOS switch SW4. The signal lines HL1 to HLM are connected to the CMOS switches SW1 and SW2. The signal lines VL1 to VLM are connected to the CMOS switches SW3 and SW4. The drive lines DL1 to DLM are connected to the CMOS switches SW1 and SW4. The sense lines SL1 to SLM are connected to the CMOS switches SW2 and SW3.

When the signal of the control line CL is made Low, the signal lines HL1 to HLM become connected to the drive lines DL1 to DLM and the signal lines VL1 to VLM become connected to the sense lines SL1 to SLM. When the signal of the control line CL is made High, the signal lines HL1 to HLM become connected to the sense lines SL1 to SLM and the signal lines VL1 to VLM become connected to the drive lines DL1 to DLM.

The A/D converter 8 converts from analog to digital a linear sum of electric charges read out via the sense lines SL1 to SLM, which electric charges correspond to the capacitors, and supplies the converted linear sum to the capacitance distribution calculation section 9.

The capacitance distribution calculation section 9 calculates, based on (i) the linear sum of the electric charges corresponding to the capacitors, which linear sum has been supplied from the A/D converter 8, and (ii) the code sequence, a capacitance distribution on the touch panel 3 and supplies the calculated capacitance distribution to a touch recognition section 10. The touch recognition section 10 recognizes a touched position on the touch panel 3 based on the capacitance distribution supplied from the capacitance distribution calculation section 9.

The capacitance distribution detection circuit 2 includes the timing generator 7. The timing generator 7 generates (i) a signal for specifying an operation of the driver 5, (ii) a signal for specifying an operation of the sense amplifier 6, and (iii) a signal for specifying an operation of the A/D converter 8, and supplies these signals to the driver 5, the sense amplifier 6, and the A/D converter 8, respectively.

Operation of Touch Panel System 50

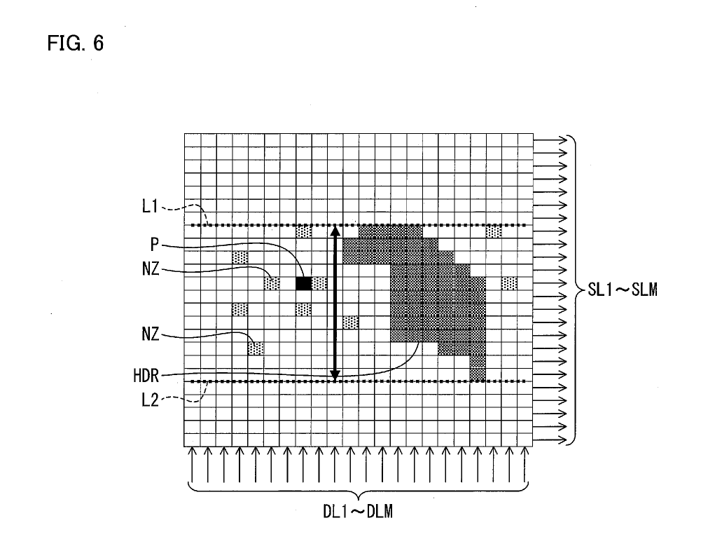

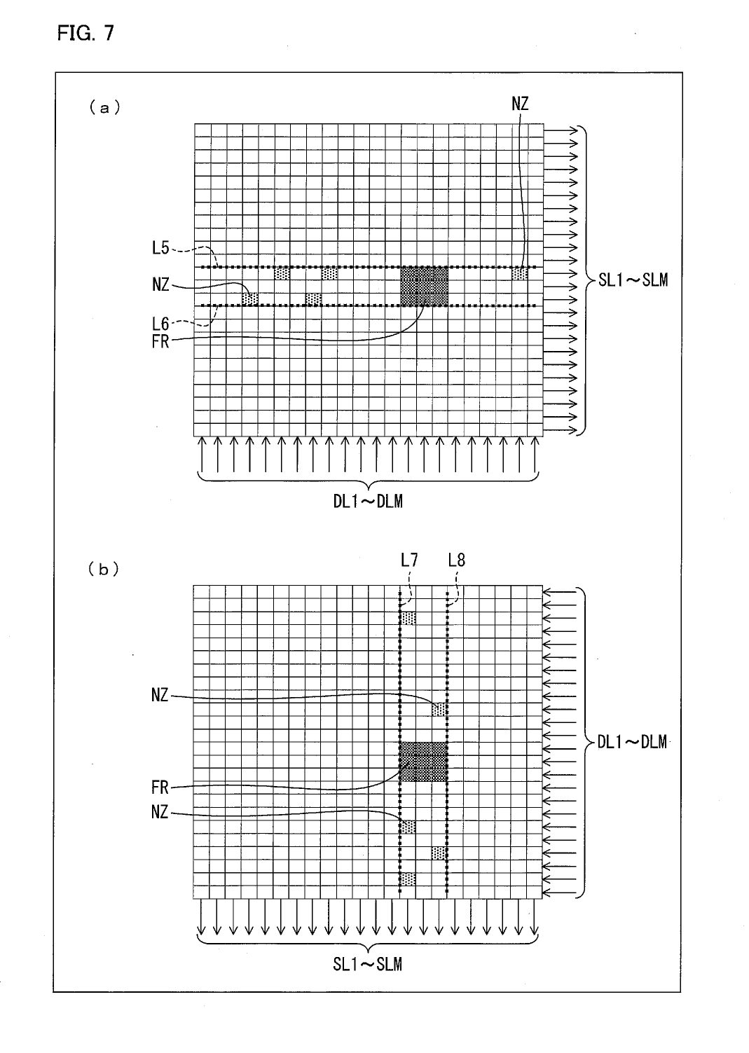

(a) and (b) of FIG. 5 and FIG. 6 are schematic views each illustrating an operation method of the touch panel system 50. As illustrated in FIG. 6, there is a problem that a phantom noise NZ is generated in an area which is between circumscribing lines L1 and L2 that circumscribe a hand placing region HDR along the sense lines SL1 to SLM and which is outside the hand placing region HDR. However, when a pen signal is inputted on a sense line that does not overlap the hand placing region HDR, i.e., on a pen input position P outside the circumscribing lines L1 and L2 as illustrated in (a) of FIG. 5, this pen signal is detectable since no phantom noise NZ is generated on the sense line which passes through the pen input position P, thereby having no deterioration in SNR caused by the phantom noise NZ.

Hence, in a case where the hand placing region HDR and the pen input position P are in a positional relationship as illustrated in FIG. 6, when a linear sum signal is read from signal lines in a horizontal direction while signal lines in a vertical direction are driven, a phantom noise is generated, whereas when the drive lines DL1 to DLM and the sense lines SL1 to SLM are switched over therebetween, to have the signal lines HL1 to HLM in the horizontal direction function as the drive lines DL1 to DLM and the signal lines VL1 to VLM in the vertical direction function as the sense lines SL1 to SLM, as illustrated in (b) of FIG. 5, so that the signal is detected outside the area between the circumscribing lines L3 and L4, it is possible to detect the pen signal of the pen input position P.

Accordingly, for example, by alternately switching over every one frame with the multiplexer 4 between (i) a first connection state ((b) of FIG. 5) in which the signal lines HL1 to HLM are connected to the drive lines DL1 to DLM of the driver 5 and the signal lines VL1 to VLM are connected to the sense lines SL1 to SLM of the sense amplifier 6 and (ii) a second connection state (FIG. 6) in which the signal lines HL1 to HLM are connected to the sense lines SL1 to SLM of the sense amplifier 6 and the signal lines VL1 to VLM are connected to the drive lines DL1 to DLM of the driver 5, it is possible to detect the pen signal at one of timings of the first connection state and the second connection state, even if the phantom noise NZ is generated due to the hand placing region HDR. Since the phantom noise NZ is generated in the other timing, the SNR of the pen signal is reduced to half. However, by alternately switching over between the first connection state and the second connection state, it is possible to detect the pen signal even if the phantom noise NZ is generated caused by the hand placing region HDR.

Therefore, for example, the touch panel system 50 (i) drives, at a first timing, the signal lines HL1 to HLM so that the signal lines VL1 to VLM output electric charges that correspond to the capacitors, (ii) controls, with use of the multiplexer 4, at a second timing subsequent to the first timing, switching of connection of the signal lines HL1 to HLM and the signal lines VL1 to VLM, and (iii) drives, at a third timing subsequent to the second timing, the signal lines VL1 to VLM so that the signal lines HL1 to HLM output the electric charges that correspond to the capacitors.

The capacitance distribution calculation section 9 is configured so that a signal read out through a sense line from a capacitor disposed in a rectangle circumscribing the hand placing region HDR, is not received. The hand placing region HDR is a region in which a hand holding the electrically conductive pen for input is placed on the touch panel; the capacitance distribution calculation section 9 can be configured to recognize this region by image recognition means not illustrated. Moreover, the configuration may be provided so that a user of the touch panel system la specifies the hand placing region HDR.

Moreover, when the switching between the drive lines and the sense lines similarly to the above is carried out in a smart phone with which no hand placing region HDR by pen input occurs, although a signal to be detected generated by touching with a finger is generated in either of the driving states, an error signal caused by the phantom noise is removable since a position in which the phantom noise is generated differs depending on the switching of the drive lines and the sense lines.

(a) and (b) of FIG. 7 are schematic views each illustrating another operation method of the touch panel system 50. As illustrated in (a) of FIG. 7, when the vertical signal lines VL1 to VLM are connected to the drive lines DL1 to DLM and are driven and the horizontal signal lines HL1 to HLM are connected to the sense lines SL1 to SLM, the phantom noise NZ that is generated in an area which is between circumscribing lines L5 and L6 (circumscribing a finger-touched region FR in a horizontal direction) and which is outside the finger-touched region FR, is read out via the sense line together with a signal corresponding to the finger-touched region FR. Thereafter, as illustrated in (b) of FIG. 7, when the horizontal signal lines HL1 to HLM are connected to the drive lines DL1 to DLM and are driven and the vertical signal lines VL1 to VLM are connected to the sense lines SL1 to SLM, the phantom noise NZ generated between the circumscribing lines L7 and L8 that circumscribe the finger-touched region FR in a vertical direction, is read out via a sense line together with a signal corresponding to the finger-touched region FR.

The phantom noise NZ generated between the circumscribing lines L5 and L6 as illustrated in (a) of FIG. 7 and the phantom noise NZ generated between the circumscribing lines L7 and L8 as illustrated in (b) of FIG. 7 are generated randomly, unrelated to each other. Accordingly, when an AND operation is carried out with respect to (i) a signal corresponding to the phantom noise NZ generated between the circumscribing lines L5 and L6 and to the finger-touched area FR, the signal being read out via the sense lines as illustrated in (a) of FIG. 7, and (ii) a signal corresponding to the phantom noise NZ generated between the circumscribing lines L7 and L8 and to the finger-touched area FR, the signal being read out via the sense lines as illustrated in (b) of FIG. 7, it is possible to cancel the phantom noise NZ generated between the circumscribing lines L5 and L6 and the phantom noise NZ generated between the circumscribing lines L7 and L8.

Problem

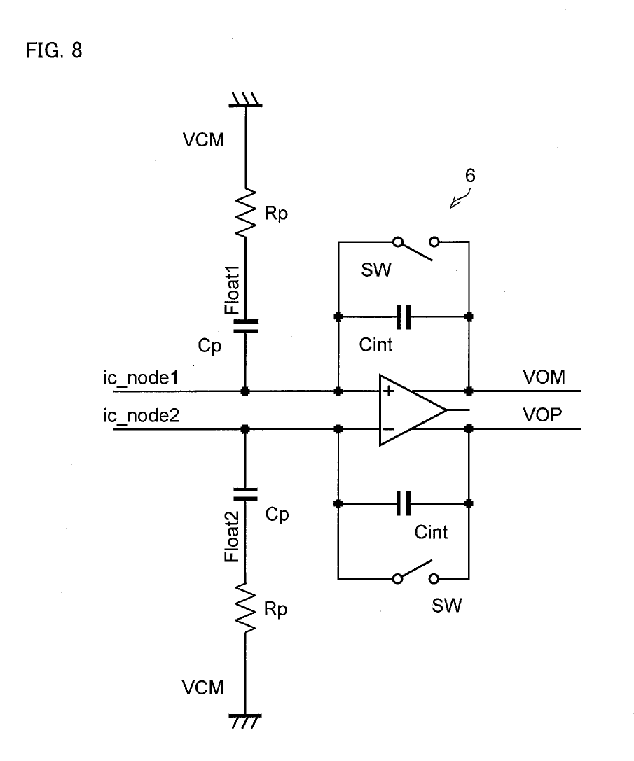

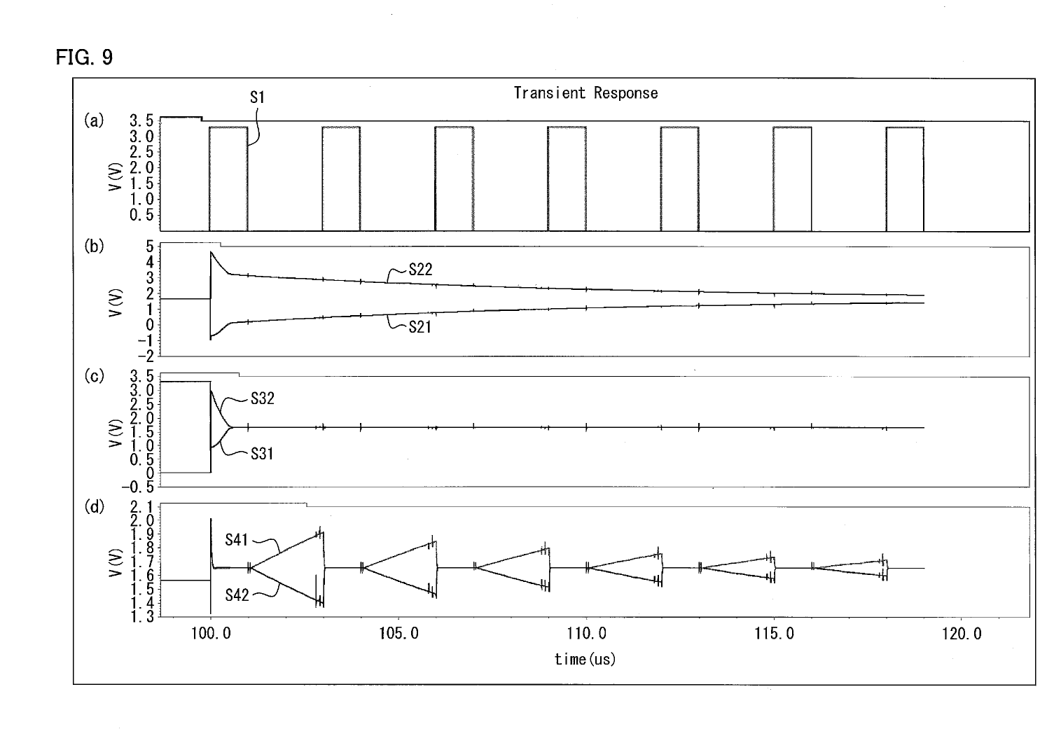

FIG. 8 is a circuit diagram illustrating floating nodes which are capacitive-coupled with the first and second signal lines of the touch panel system via parasitic capacitors.

A differential amplifier of the sense amplifier 6 included in the capacitance distribution detection circuit 2 is connected to adjacent first signal lines or adjacent second signal lines of the touch panel 3 via adjacent sense lines. One of the adjacent signal lines is capacitive-coupled with a floating node Float 1 via a parasitic capacitor Cp. The floating node Float 1 is DC-grounded via a resistor Rp which has a relatively high resistance. The other of the adjacent signal lines is capacitive-coupled with a floating node Float 2 via a parasitic capacitor Cp. The floating node Float 2 is DC-grounded via a resistor Rp which has a relatively high resistance. Between an inverted input of the differential amplifier and a corresponding output thereof, a switch SW and an integral capacitor Cint are coupled with each other in parallel. Between a non-inverted input of the differential amplifier and a corresponding output thereof, a switch SW and an integral capacitor Cint are coupled with each other in parallel.

No problem would occur if the floating nodes Float1 and Float2 are electrically connected to nowhere. In reality, the floating nodes Float1 and Float2 are DC-grounded with a relatively high resistance in the order of megaohm or gigaohm. This resistance is expressed as a resistance Rp.

(a) of FIG. 9 is a waveform chart showing a control signal 51 of the touch panel system. (b) of FIG. 9 is a waveform chart showing voltage signals S21 and S22 of the floating nodes. (c) of FIG. 9 is a waveform chart showing voltage signals S31 and S32 of the first and second signal lines. (d) of FIG. 9 is a waveform chart showing an output waveform of the differential amplifier connected to the first signal lines and second signal lines.

For convenience, the following description will be provided based on an assumption that an intersection where the first and second signal lines intersect with each other does not have a capacitor. Until a time 100 μsec, one of the first signal line and the second signal line is driven as a drive line, and on and after the time 100 μsec, the first signal line and the second signal line are switched so that the one of the first signal line and the second signal line is used as a sense line.

As illustrated in (c) of FIG. 9, the voltage signal S31 indicates that the first signal line or the second signal line is driven at 3.3 V until a time 100 μsec. On and after the time 100 μsec, the first signal line or second signal line is used as a sense line, and corresponding switches SW are closed and the voltages are converged to a common voltage. The common voltage is approximately a half of a power supply voltage, and is approximately 1.65 V herein. The voltage signal S32 indicates that the adjacent first signal line or the adjacent second signal line is driven at 0 V until a time 100 μsec. On and after the time 100 μsec, the first signal line or second signal line is used as a sense line, and corresponding switches SW are closed and the voltages are converged to a common voltage.

The above operation itself does not have any problems. However, as illustrated in (b) of FIG. 9, the voltage signal S21 of the floating node Float 1 increases with a slow time constant under the influence of a change in the voltage signal S31. The voltage signal S22 of the floating node Float2 decreases with a slow time constant under the influence of a change in the voltage signal S32.

In a case where the resistance of the resistor Rp is extremely small, the floating nodes Float1 and Float2 are immediately grounded to a power supply voltage VCM, and consequently the voltage signals S21 and S22 of the floating nodes Float1 and Float2 are immediately converted to the common voltage. However, in a case where the resistances of the resistors Rp are relatively large, the voltage signals S21 and S22 change gradually. As above, in a case where the floating nodes are DC-grounded via the resistors Rp having relatively high resistances in the order of megaohm or gigaohm, the voltage signals S21 and S22 indicative of noises resulting from the floating nodes change with a slow time constant.

Consequently, the voltage of the floating node changes at an unintended timing, thus causing the parasitic capacitor Cp to be driven. As a result, an unintended noise enters the differential amplifier via the first signal line or the second signal line, and the noise is mixed into the output signals S41 and S42 of the differential amplifier as illustrated in (d) of FIG. 9. In this model, since no change occurs in capacitance, an expected output of the differential amplifier is zero. However, when the floating node exists, a noise is generated due to the floating node.

### First Embodiment

The following description will discuss an embodiment of the present invention in details.

Configuration of Touch Panel System 1a

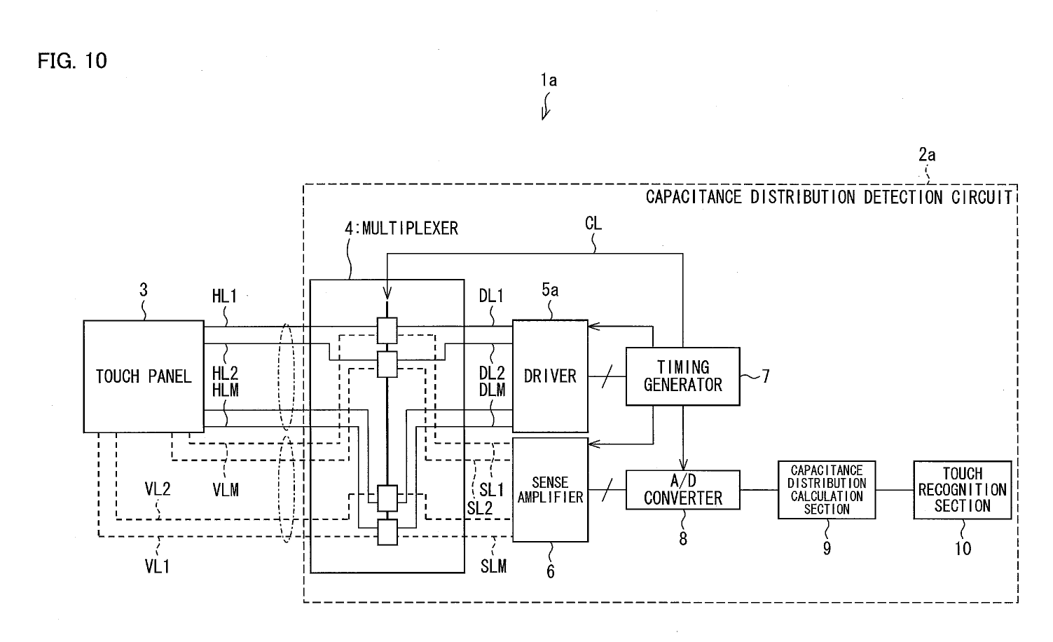

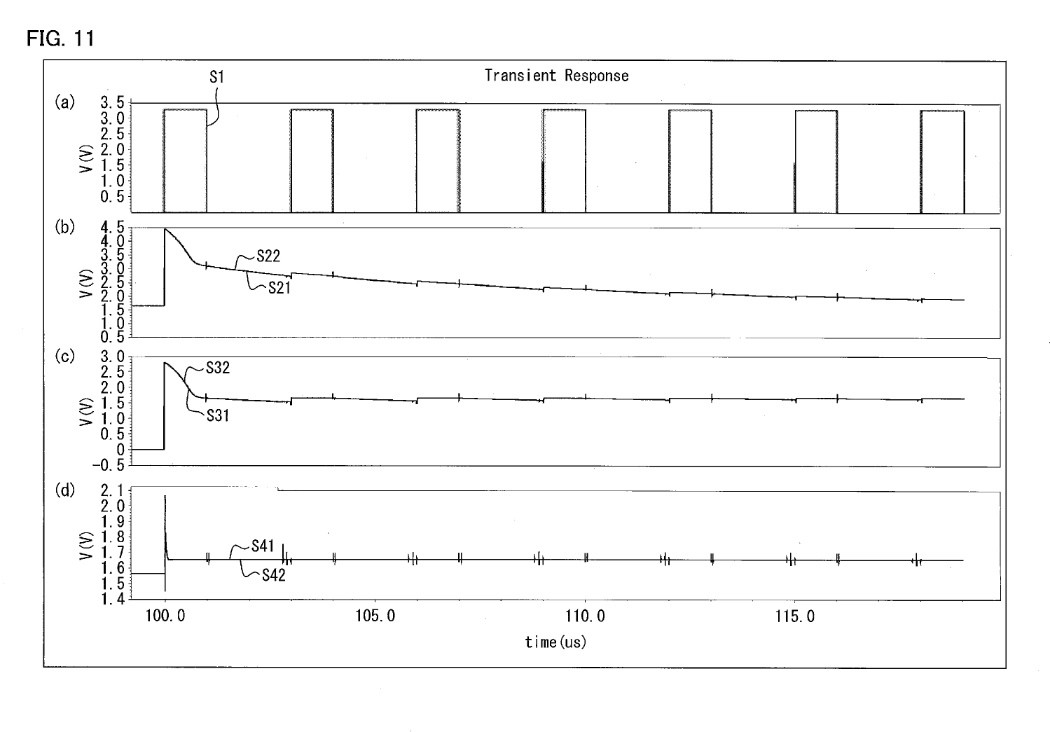

FIG. 10 is a block diagram illustrating a configuration of a touch panel system 1a in accordance with First Embodiment. Members which are the same as those described above are given the same reference signs and detailed explanations thereof are omitted.

The touch panel system 1a includes a capacitance distribution detecting device (touch panel controller) 2a.

The capacitance distribution detecting device 2a includes a driver (driving section) 5a. A sense amplifier (amplifier) 6 is constituted by a differential amplifier which amplifies a difference between outputs of adjacent signal lines. The driver 5a drives the signal lines HL1 to HLM (a plurality of first signal lines) at a first timing so that the signal lines VL1 to VLM (a plurality of second signal lines) output first linear sum signals based on electric charges of capacitors, respectively. The sense amplifier 6 amplifies, at the first timing, the first linear sum signals respectively outputted from the signal lines VL1 to VLM.

The driver 5a drives the signal lines VL1 to VLM (a plurality of second signal lines) at a second timing which is a driving timing subsequent to the first timing, in accordance with a code sequence, so that the signal lines HL1 to HLM (a plurality of first signal lines) output second linear sum signals based on electric charges of the capacitors, respectively. The sense amplifier 6 amplifies, at the second timing, the second linear sum signals respectively outputted from the signal lines HL1 to HLM (a plurality of first signal lines).

The capacitance distribution calculation section 9 calculates a capacitance distribution based on (i) the second linear sum signals which have been amplified by the sense amplifier 6 and subjected to A/D conversion by the A/D converter 8 and (ii) the code sequence.

Thus, the driver 5a drives, with the same driving voltage, the signal lines HL1 to HLM immediately before being sensed.

Operation of Touch Panel System 1a

(a) of FIG. 11 is a waveform chart showing a control signal Si of the touch panel system 1a. (b) of FIG. 11 is a waveform chart showing voltages of floating nodes of the touch panel system 1a. (c) of FIG. 11 is a waveform chart showing voltages of the signal lines HL1 to HLM of the touch panel system 1a. (d) of FIG. 11 is a waveform chart showing an output waveform of the differential amplifier connected to the signal lines HL1 to HLM.

When the signal lines HL1 to HLM immediately before being sensed are driven with the same driving voltage, voltage signals S21 and S22 of two floating nodes respectively capacitive-coupled with two adjacent signal lines which are connected to the differential amplifier change similarly as illustrated in (b) of FIG. 11. Accordingly, by differential amplification made by the differential amplifier, respective noises resulting from two floating nodes cancel each other, and noises are thus reduced.

In the example illustrated in (c) of FIG. 11, before the time 100 μsec, the voltage signal S31 is 3.3 V and the voltage signal S32 is 0 V. In the present embodiment, since the signal lines HL1 to HLM are driven with the same drive voltage (e.g. 0 V) immediately before being sensed, both of the voltage signals S31 and S32 become 0 V before the time 100 μsec, and the voltage signals S31 and S32 change while showing the same waveform on and after the time 100 μsec. Since the voltage signals S31 and S32 of the signal lines change while showing the same waveform, the voltage signals S21 and S22 of the floating nodes also change while showing the same waveform. Since the voltage signals S21 and S22 of the adjacent floating nodes change while showing the same waveform, although noises resulting from the two floating nodes enter the signal lines, the noises cancel each other and do not appear in the output signals S41 and S42 of the differential amplifier as illustrated in (d) of FIG. 11.

In a case where all the signal lines HL1 to HLM immediately before being read by the sense amplifier 6 are driven with the same drive voltage as above, when the signal lines HL1 to HLM are driven in accordance with a code sequence such as an M sequence, all the signal lines HL1 to HLM are driven with the same drive voltage with use of a non-decoded dummy pattern because the M sequence does not have a code sequence which allows all the signal lines to be driven with the same drive voltage.

For example, all the signal lines HL1 to HLM may be driven with 0 V or may be driven with 3.3 V. Alternatively, all the signal lines HL1 to HLM may be driven with a common voltage.

In a case where the signal lines HL1 to HLM are driven with a common voltage in a drive mode and then the signal lines HL1 to HLM transit to a sense mode, no change in voltage occurs. Accordingly, it is preferable to drive all the signal lines HL1 to HLM with a common voltage. A common voltage is a voltage at a time when input/output of a differential amplifier is reset, and generally a half of a power supply voltage.

In a case where the signal lines are driven in accordance with a code sequence called a Hadamard matrix, since the Hadamard matrix includes a sequence in which all of codes corresponding to all of the respective signal lines are 1, driving the signal lines with this sequence allows the result of the driving to be used for decoding as well.

### Second Embodiment

Configuration of Touch Panel System 1b

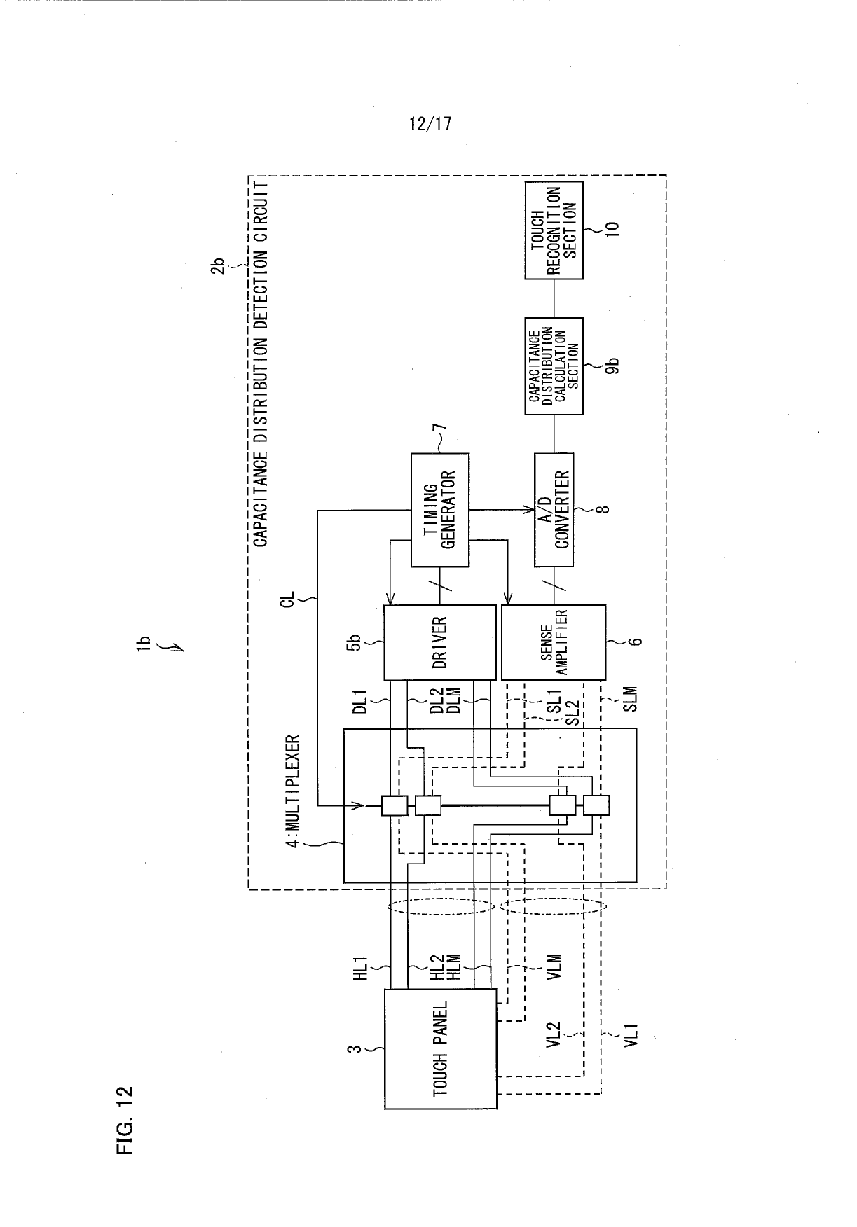

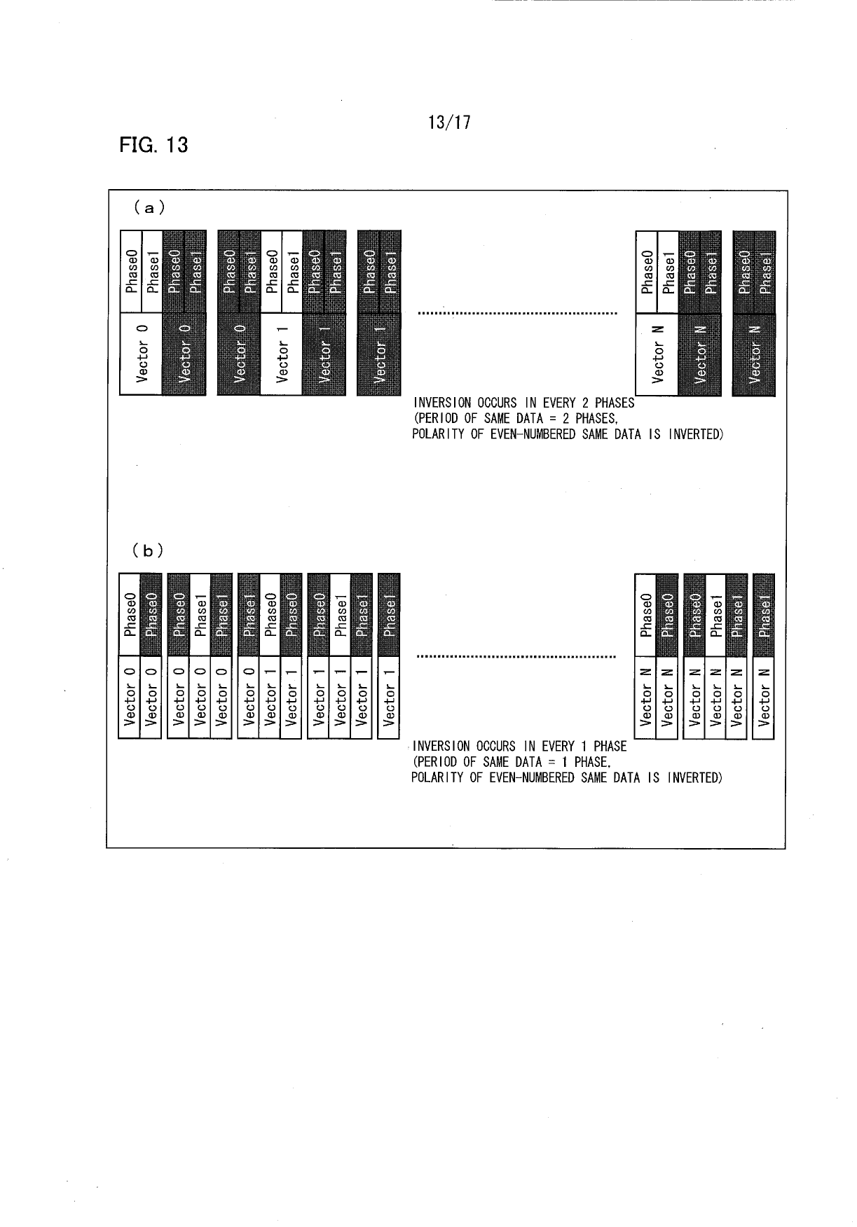

FIG. 12 is a block diagram illustrating a configuration of a touch panel system 1b in accordance with Second Embodiment. Members which are the same as those described above are given the same reference signs and detailed explanations thereof are omitted.

The touch panel system 1b includes a capacitance distribution detecting device (touch panel controller) 2b. The capacitance distribution detecting device 2b includes a driver (driving section) 5b and a capacitance distribution calculation section 9b.

The driver 5b drives the signal lines HL1 to HLM (a plurality of first signal lines) at a first timing in accordance with a code sequence so that the signal lines VL1 to VLM (a plurality of second signal lines) output first linear sum signals based on electric charges of the capacitors, respectively. The sense amplifier 6 amplifies, at the first timing, the first linear sum signals respectively outputted from the signal lines VL1 to VLM.

The driver 5b drives the signal lines VL1 to VLM at a second timing in accordance with the code sequence, so that the signal lines HL1 to HLM output second linear sum signals based on electric charges of the capacitors, respectively. The sense amplifier 6 amplifies, at the second timing, the second linear sum signals respectively outputted from the signal lines HL1 to HLM.

The signal lines VL1 to VLM are capacitive-coupled with the floating nodes via parasitic capacitors, respectively. The driver 5b drives the signal lines HL1 to HLM so that polarities of the first linear sum signals are inverted in time sequence. The capacitance distribution calculation section 9b carries out a subtraction process, during decoding, in response to the inversion driving.

Operation of Touch Panel System 1b

(a) and (b) of FIG. 13 are views each illustrating a method of inversely driving an electrostatic capacitor in the touch panel system 1b.

(a) of FIG. 13 illustrates a method of performing inversion driving for the even-numbered driving while continuing the driving performed on a vector-by-vector basis (the even-numbered driving to be performed by inversion driving is indicated in a white pattern on a black ground). First, driving is performed based on the vector driving Vector 0 of the frame driving Frame 0. Then, inversion driving is performed based on the vector driving Vector 0 of the frame driving Frame 1. Next, driving is performed based on the vector driving Vector 0 of the frame driving Frame 2. Next, inversion driving is performed based on the vector driving Vector 0 of the frame driving Frame 3. The inversion occurs in every two phase drivings. A period of the same data is a period corresponding to two phase drivings. The polarities of even-numbered time-series data of the same data are inverted by the inversion driving.

(b) of FIG. 13 illustrates an example of performing inversion driving for the even-numbered driving while continuing the phase driving (the even-numbered driving to be performed by inversion driving is indicated in a white pattern on a black ground). First, driving is performed based on the phase Phase 0 which is included in the vector driving Vector 0 of the frame driving Frame 0. Then, inversion driving is performed based on the phase Phase 0 which is included in the vector driving Vector 0 of the frame driving Frame 1.

Next, driving is performed based on the phase Phase 0 which is included in the vector driving Vector 0 of the frame driving Frame 2. Then, inversion driving is performed based on the phase Phase 0 which is included in this vector driving Vector 0 of the frame driving Frame 3.

The inversion occurs in every one phase driving. A period of the same data is a period corresponding to one phase driving. The polarities of the same data are inverted at even-numbered driving.

As described above, by inversely driving each of the plurality of electrostatic capacitors by the touch panel system 1b, it is possible to reduce noises with a low frequency. Since voltages of the floating nodes change gradually as illustrated in (b) of FIG. 9, the noises resulting from the floating nodes can be considered as low frequency noises. Accordingly, by inversely driving each of the plurality of electrostatic capacitors as above, it is possible to subdue the low frequency noises.

### Third Embodiment

Configuration of Touch Panel System 1c

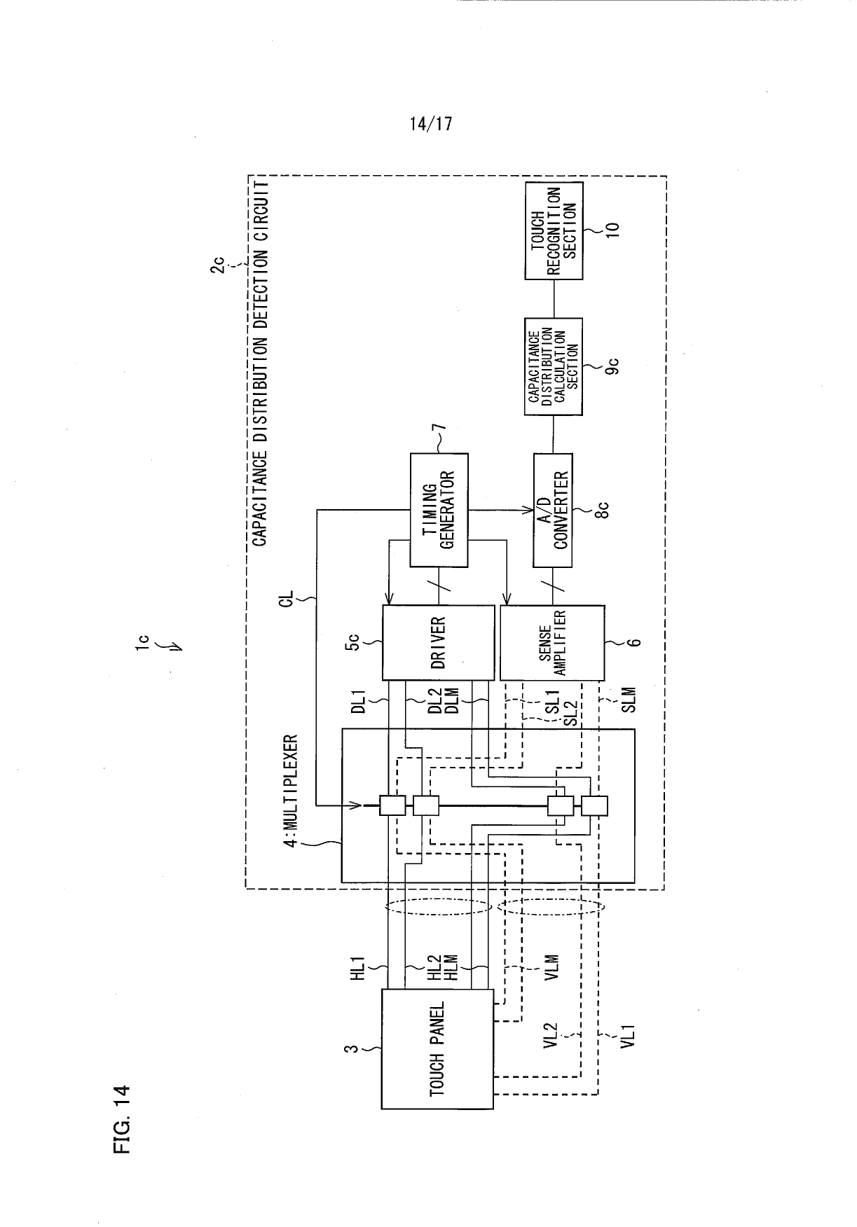

FIG. 14 is a block diagram illustrating a configuration of a touch panel system 1c in accordance with Third Embodiment. Members which are the same as those described above are given the same reference signs and detailed explanations thereof are omitted.

The touch panel system 1c includes a capacitance distribution detecting device (touch panel controller) 2c.

The capacitance distribution detecting device 2c includes a driver (driving section) 5c, an A/D converter 8c, and a capacitance distribution calculation section 9c.

Signal lines HL1 to HLM (a plurality of first signal lines) are capacitive-coupled with a first floating node via a first parasitic capacitor. Signal lines VL1 to VLM (a plurality of second signal lines) are capacitive-coupled with second floating nodes via second parasitic capacitors, respectively. The capacitance distribution detecting device 2c has a calibration mode in which no touch input to a capacitor is made and a scan mode in which a touch input to the capacitor is detected.

The driver 5c drives the signal lines HL1 to HLM at a calibration mode first timing in accordance with a code sequence so that the signal lines VL1 to VLM output calibration mode first linear sum signals based on electric charges of the capacitors, respectively, and drives the signal lines VL1 to VLM at a calibration mode second timing in accordance with the code sequence so that the signal lines HL1 to HLM output calibration mode second linear sum signals based on electric charges of the capacitors, respectively.

The sense amplifier 6 amplifies, at the calibration mode first timing, the calibration mode first linear sum signals respectively outputted from the signal lines VL1 to VLM, and amplifies, at the calibration mode second timing, the calibration mode second linear sum signals respectively outputted from the signal lines HL1 to HLM.

The capacitance distribution calculation section 9c calculates a calibration mode capacitance distribution based on the calibration mode first linear sum signals, the calibration mode second linear sum signals, and the code sequence.

The driver 5c drives the signal lines HL1 to HLM at a scan mode first timing in accordance with the code sequence so that the signal lines VL1 to VLM output scan mode first linear sum signals based on electric charges of the capacitors, respectively, and drives the signal lines VL1 to VLM at a scan mode second timing in accordance with the code sequence so that the signal lines HL1 to HLM output scan mode second linear sum signals based on electric charges of the capacitors, respectively.

The sense amplifier 6 amplifies, at the scan mode first timing, the scan mode first linear sum signals respectively outputted from the signal lines VL1 to VLM, and amplifies, at the scan mode second timing, the scan mode second linear sum signals respectively outputted from the signal lines HL1 to HLM.

The capacitance distribution detecting device 2c includes a switching circuit (not illustrated) at a stage previous to the sense amplifier 6. This switching circuit switches an input state of each amplifier circuit provided in the sense amplifier 6 between (i) an even-numbered phase state (phase 0) where a 2n-th sense line and a (2n+1)-th sense line receive inputs and (ii) an odd-numbered phase state (phase 1) where a (2n+1)-th sense line and a (2n+2)-th sense line receive inputs.

The capacitance distribution calculation section 9c calculates a scan mode capacitance distribution based on the scan mode first linear sum signals, the scan mode second linear sum signals, and the code sequence, and calculates distribution of capacitances of the plurality of capacitors by subtracting the calibration mode capacitance distribution from the scan mode capacitance distribution. Operation timing of the capacitance distribution detecting device 2c in the calibration mode is equal to operation timing of the capacitance distribution detecting device 2c in the scan mode.

The operation timing includes (i) the number of a frame to be added in frame driving in accordance with the code sequence, (ii) the order of driving in accordance with the code sequence, and (iii) a sampling frequency of the calibration mode first and second linear sum signals and a sampling frequency of the scan mode first and second linear sum signals.

Operation of Touch Panel System 1c

The capacitance distribution detecting device 2c detects capacitance. In a case where the capacitance distribution detecting device 2c is actually connected to the touch panel 3, which has production tolerance, an output of the touch panel 3 is not zero and certain output data is outputted, even when no touch input is made on the touch panel 3. This operation mode is called a calibration mode, and output data in the calibration mode is called calibration data. An operation mode in which a touch input is detected is called a scan mode, and output data in the scan mode is called scanning data. A distribution of capacitances is calculated by subtracting the calibration data from the scanning data.

In the touch panel system, the same operation is repeated several times in order to obtain a signal with high accuracy. For example, in a case of parallel driving, driving is performed based on first vector in the code sequence, driving is performed based on second vector, and drivings are performed on subsequent vectors until driving is performed based on eighth vector, and at that timing, the capacitance distribution calculation section can perform decoding calculation in order to calculate capacitance per one frame.

Next, completely the same operation as above is carried out. This operation is called a second frame. It is possible to calculate a capacitance in the second frame. When such an operation is repeated several times, e.g. eight times, capacitance data of eight frames is calculated. The capacitance data of eight frames is averaged, and the averaged data is considered as a true capacitance.

The number of repeating frames for calculating the true capacitance is called a frame addition number. Since a noise mixed into a signal due to the floating node has a fixed pattern which is constant with respect to each driving of signal lines, making the frame addition number for the calibration mode and the frame addition number for the scan mode equal to each other allows subtraction of the calibration mode capacitance distribution from the scan mode capacitance distribution, resulting in cancellation and elimination of the noise.

(a), (b), and (c) of FIG. 15 are views each illustrating a unit of driving performed on the capacitors in the touch panel system.

Even when the order of driving based on a code sequence is identical between the calibration mode and the scan mode, the noise can be cancelled and eliminated by subtracting the calibration mode capacitance distribution from the scan mode capacitance distribution.

(a) of FIG. 15 is a diagram for explaining driving performed on a frame-by-frame basis. The touch panel system 1c repeats (M+1) frame drivings Frame 0 through Frame M in this order. Each of the frame drivings Frame 0 through Frame M includes (N+1) vector drivings Vector 0 through Vector N. Each of the vector drivings Vector 0 through Vector N includes an even-numbered phase driving Phase 0 and an odd-numbered phase driving Phase 1.

At the even-numbered phase driving Phase 0 in the even-numbered phase state (phase 0), a voltage corresponding to an even-numbered line—odd-numbered line (e.g. (SL2-SL1), (SL4-SL3), and (SL6-SL5) is outputted. At the odd-numbered phase driving Phase 1 in the odd-numbered phase state (phase 1), a voltage corresponding to an odd-numbered line—even-numbered line (e.g. (SL3-SL2), (SL5-SL4), and (SL7-SL6) is outputted.

(b) of FIG. 15 is a diagram for explaining driving performed on a vector-by-vector basis. First, drivings are successively performed based on only the vector driving Vector 0 which is included in each of the frame drivings Frame 0 through Frame M, in the following order: the vector driving Vector 0 of the frame driving Frame 0, the vector driving Vector 0 of the frame driving Frame 1, the vector driving Vector 0 of the frame driving Frame 2, . . . , and the vector driving Vector 0 of the frame driving Frame M.

Then, drivings are successively performed based on only the vector driving Vector 1 which is included in each of the frame drivings Frame 0 through Frame M, in the following order: the vector driving Vector 1 of the frame driving Frame 0, the vector driving Vector 1 of the frame driving Frame 1, the vector driving Vector 1 of the frame driving Frame 2, . . . , and the vector driving Vector 1 of the frame driving Frame M. Next, drivings are successively performed based on only the vector driving Vector 2 which is included in each of the frame drivings Frame 0 through Frame M, in the following order: the vector driving Vector 2 of the frame driving Frame 0, the vector driving Vector 2 of the frame driving Frame 1, the vector driving Vector 2 of the frame driving Frame 2, . . . , and the vector driving Vector 2 of the frame driving Frame M. Similar drivings are performed until the vector driving Vector N.

(c) of FIG. 15 is a diagram for explaining driving performed on a phase-by-phase basis. First, drivings are successively performed based on only the phase driving Phase0 of the vector driving Vector 0 which is included in each of the frame drivings Frame 0 through Frame M, in the following order: the phase driving Phase 0 which is included in the vector driving Vector 0 of the frame driving Frame 0, the phase driving Phase 0 which is included in the vector driving Vector 0 of the frame driving Frame 1, the phase driving Phase0 which is included in the vector driving Vector 0 of the frame driving Frame 2, . . . , and the phase driving Phase 0 which is included in the vector driving Vector 0 of the frame driving Frame M.

Then, drivings are successively performed based on only the phase driving Phase 1 of the vector driving Vector 0 which is included in each of the frame drivings Frame 0 through Frame M, in the following order: the phase driving Phase 1 which is included in the vector driving Vector 0 of the frame driving Frame 0, the phase driving Phase 1 which is included in the vector driving Vector 0 of the frame driving Frame 1, the phase driving Phase 1 which is included in the vector driving Vector 0 of the frame driving Frame 2, . . . , and the phase driving Phase 1 which is included in the vector driving Vector 0 of the frame driving Frame M.

Next, drivings are successively performed based on only the phase driving Phase 0 of the vector driving Vector 1 which is included in each of the frame drivings Frame 0 through Frame M, in the following order: the phase driving Phase 0 which is included in the vector driving Vector 1 of the frame driving Frame 0, the phase driving Phase 0 which is included in the vector driving Vector 1 of the frame driving Frame 1, the phase driving Phase 0 which is included in the vector driving Vector 1 of the frame driving Frame 2, . . . , and the phase driving Phase 0 which is included in the vector driving Vector 1 of the frame driving Frame M. Similar drivings are performed until the vector driving Vector N.

For example, when drivings both in the calibration mode and in the scan mode are performed in accordance with the order of driving performed on frame-by-frame basis as illustrated in (a) of FIG. 15, the noise can be cancelled and eliminated by subtracting the calibration mode capacitance distribution from the scan mode capacitance distribution.

When driving in the calibration mode is performed in accordance with the order of driving performed on vector-by-vector basis as illustrated in (b) of FIG. 15 and driving in the scan mode is performed in accordance with the order of driving performed on vector-by-vector basis, the noise can be cancelled and eliminated by subtracting the calibration mode capacitance distribution from the scan mode capacitance distribution.

Similarly, when driving in the calibration mode is performed in accordance with the order of driving performed on phase-by-phase basis as illustrated in (c) of FIG. 15 and driving in the scan mode is performed in accordance with the order of driving performed on phase-by-phase basis, the noise can be cancelled and eliminated by subtracting the calibration mode capacitance distribution from the scan mode capacitance distribution.

### Fourth Embodiment

Configuration of Touch Panel System 1d

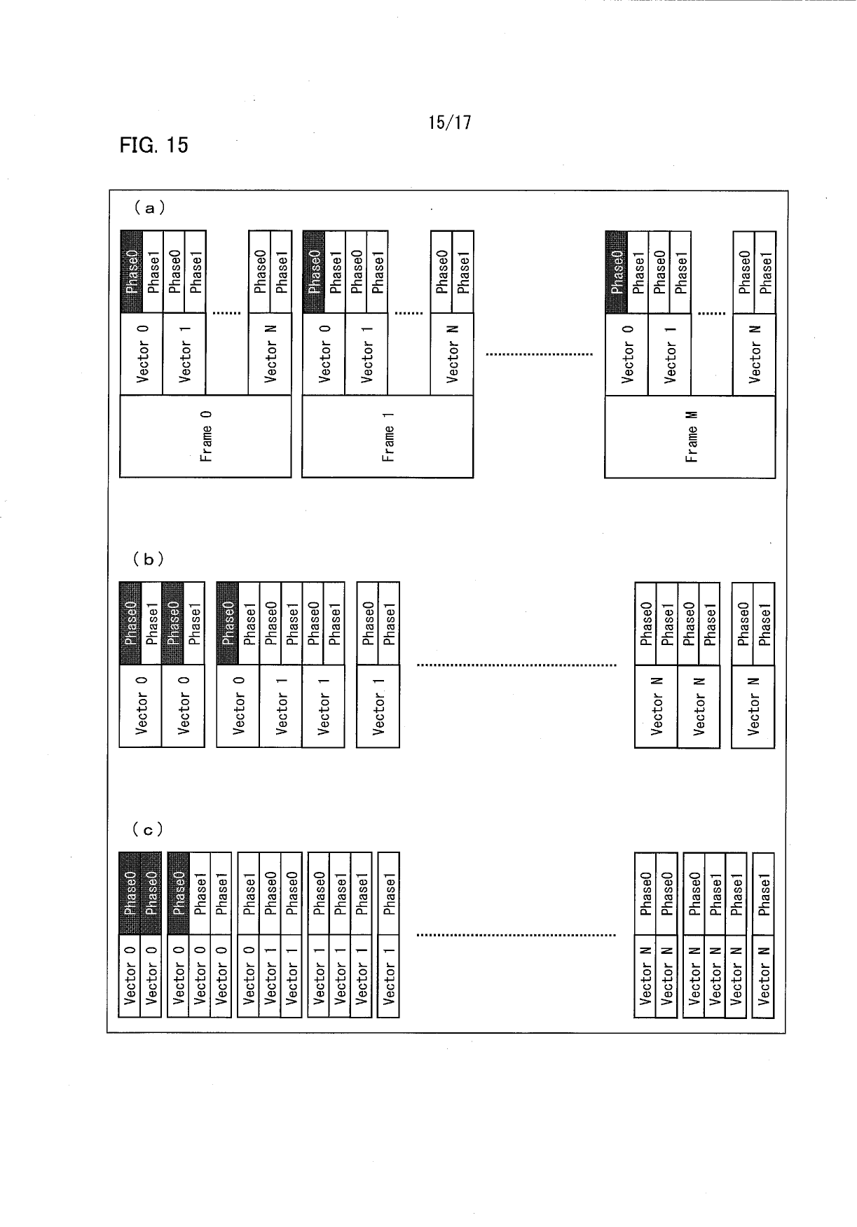

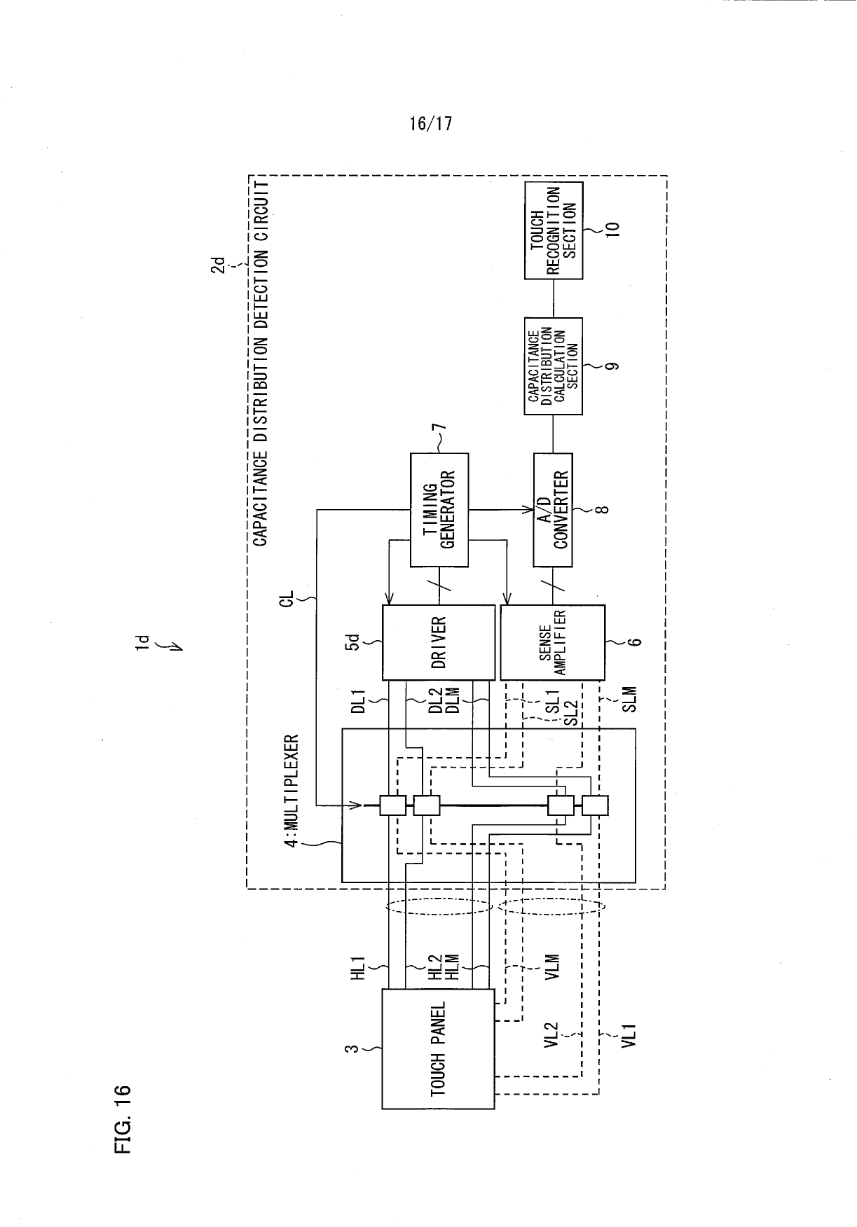

FIG. 16 is a block diagram illustrating a configuration of a touch panel system id in accordance with Fourth Embodiment. Members which are the same as those described above are given the same reference signs and detailed explanations thereof are omitted.

The touch panel system 1d includes a capacitance distribution detecting device (touch panel controller) 2d. The capacitance distribution detecting device 2d includes a driver (driving section) 5d.

The driver 5d drives the signal lines HL1 to HLM (a plurality of first signal lines) at a first timing in accordance with a code sequence so that the signal lines VL1 to VLM (a plurality of second signal lines) output first linear sum signals based on electric charges of the capacitors, respectively. The sense amplifier 6 amplifies, at the first timing, the first linear sum signals respectively outputted from the signal lines VL1 to VLM.

The driver 5b drives the signal lines VL1 to VLM at a second timing in accordance with the code sequence, so that the signal lines HL1 to HLM output second linear sum signals based on electric charges of the capacitors, respectively. The sense amplifier 6 amplifies, at the second timing, the second linear sum signals respectively outputted from the signal lines HL1 to HLM. The second timing is a time after connection of the signal lines HL1 to HLM has been switched from the driver 5b to the sense amplifier 6 and voltages of floating nodes capacitive-coupled with the signal lines HL1 to HLM via parasitic capacitors, respectively, have been stabilized.

As an example, the sense amplifier (amplifier) 6 is constituted by a differential amplifier which amplifies a difference between outputs of adjacent signal lines. However, the present invention is not limited to this example. The sense amplifier 6 may be constituted by a single amplifier instead of a differential amplifier.

Operation of Touch Panel System 1d

As illustrated in FIGS. 8 and 9, after the mode of the signal lines is inverted from the drive mode to the sense mode, the voltage signals S21 and S22 change gradually. The driver 5b waits for a next driving timing and does not perform driving until the voltage signals S21 and S22 are stabilized. Since noises resulting from floating nodes can be mixed until the voltage signals S21 and S22 are stabilized, the driver 5b does not perform driving on the signal lines VL1 to VLM via drive lines. This configuration allows reducing noises resulting from the floating nodes.

### Fifth Embodiment

Configuration of Mobile Phone 90

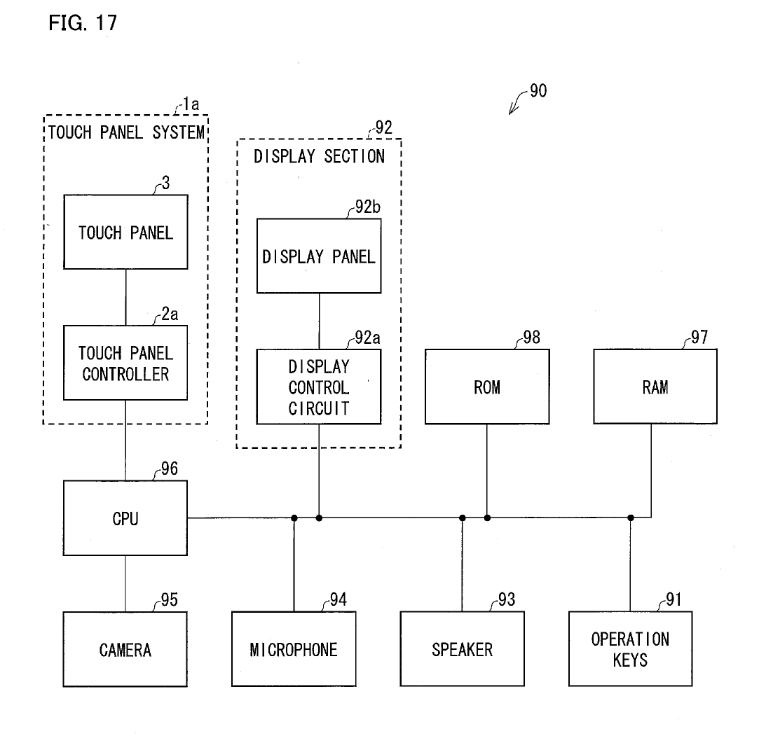

FIG. 17 is a block diagram illustrating a configuration of an electronic device (mobile phone 90) in accordance with Fifth Embodiment. The mobile phone 90 includes a CPU 96, a RAM 97, a ROM 98, a camera 95, a microphone 94, a speaker 93, operation keys 91, a display section 92 which includes a display panel 92b and a display controlling circuit 92a, and the touch panel system 1. These components are connected to each other via a data bus.

The CPU 96 controls an operation of the mobile phone 90. The CPU 96 executes a program stored in, for example, the ROM 98. A user of the mobile phone 90 enters an instruction via the operation keys 91. The RAM 97 is a volatile memory which stores therein (i) data generated by executing of a program by the CPU 96 or (ii) data entered via the operation keys 91. The ROM 98 is a nonvolatile memory which stores data therein.

The ROM 98 is a ROM, such as an EPROM (Erasable Programmable Read-Only Memory) and a flash memory, into/from which data can be written or deleted. Note that the mobile phone 90 can further be provided with an interface (IF) to which other electronic device is to be connected via a wire, though the interface is not illustrated in FIG. 21.

The camera 95 captures an image of a subject in accordance with a user's operation of the operation keys 91. Note that data of the image thus captured is stored in the RAM 97 or an external memory (e.g., a memory card). The microphone 94 receives audio from a user. The mobile phone 90 digitizes the audio (analog data), and transmits the audio thus digitized to a target (such as other mobile phone). The speaker 93 produces sounds based on data such as music data stored in the RAM 97.

The touch panel system la includes a touch panel 3 and a touch panel controller 2a. The CPU 96 controls an operation of the touch panel system 1a. The CPU 96 executes a program stored in, for example, the ROM 98. The RAM 97 is the volatile memory which stores therein data generated by executing of a program by the CPU 96. The ROM 97 is the nonvolatile memory which stores data therein.

The display controlling circuit 92a controls the display panel 92b to display an image stored in the ROM 98 or the RAM 97. The display panel 92b (i) is provided so as to overlap the touch panel 3 or (ii) has the touch panel 3 built therein.

### Conclusion

A touch panel controller (capacitance distribution detection circuit 2a) in accordance with first aspect of the present invention is a touch panel controller which calculates distribution of capacitances of a plurality of capacitors provided at respective intersections where a plurality of first signal lines (signal lines HL1 to HLM) and a plurality of second signal lines (signal lines VL1 to VLM) intersect with each other, the plurality of first signal lines being capacitive-coupled with first floating nodes via first parasitic capacitors, respectively, and the plurality of second signal lines being capacitive-coupled with second floating nodes via second parasitic capacitors, respectively, the touch panel controller including: a driving section (driver 5a) for driving, at a first timing, the plurality of first signal lines with a same driving voltage so that the plurality of second signal lines output first linear sum signals based on electric charges of the plurality of capacitors, respectively; and an amplifier (sense amplifier 6) for amplifying, at the first timing, the first linear sum signals respectively outputted from the plurality of second signal lines, the driving section driving, at a second timing which is a driving timing subsequent to the first timing, the plurality of second signal lines in accordance with a code sequence so that the plurality of first signal lines output second linear sum signals based on electric charges of the plurality of capacitors, respectively, the amplifier amplifying, at the second timing, the second linear sum signals respectively outputted from the plurality of first signal lines, the amplifier being a differential amplifier corresponding to adjacent ones of the plurality of first signal lines and adjacent ones of the plurality of second signal lines, and the touch panel controller further comprising a capacitance distribution calculation section for calculating the distribution of capacitances of the plurality of capacitors in accordance with the second linear sum signal and the code sequence.

With the above arrangement, the plurality of first signal lines output linear sum signals at driving timing immediately after the plurality of first signal lines have been driven with the same voltage, and distribution of capacitances is calculated in accordance with the linear sum signals. Since the plurality of first signal lines immediately before outputting the linear sum signal are driven with the same drive voltage, voltages of two sense lines supplied to the differential amplifier show the same behaviors, and so voltages of corresponding two floating nodes show the same behaviors. Accordingly, amplification made by the differential amplifier cancels noises resulting from the voltages of the floating nodes. This yields the effect of providing a touch panel controller capable of reducing noises resulting from floating nodes.

A touch panel controller (capacitance distribution detection circuit 2b) in accordance with second aspect of the present invention is a touch panel controller which calculates distribution of capacitances of a plurality of capacitors provided at respective intersections where a plurality of first signal lines and a plurality of second signal lines intersect with each other, the touch panel controller including: a driving section (driver 5b) for driving, at a first timing, the plurality of first signal lines in accordance with a code sequence so that the plurality of second signal lines output first linear sum signals based on electric charges of the plurality of capacitors, respectively; and an amplifier for amplifying, at the first timing, the first linear sum signals respectively outputted from the plurality of second signal lines, the driving section driving, at a second timing, the plurality of second signal lines in accordance with the code sequence so that the plurality of first signal lines output second linear sum signals based on electric charges of the plurality of capacitors, respectively, the amplifier amplifying, at the second timing, the second linear sum signals respectively outputted from the plurality of first signal lines, the plurality of second signal lines being capacitive-coupled with floating nodes via parasitic capacitors, respectively, and the driving section driving the plurality of first signal lines so that polarities of the first linear sum signals are inverted in time sequence.

With the above arrangement, the driving section drives the plurality of first signal lines so that polarities of the first linear sum signals are inverted in time sequence. Accordingly, low frequency noises can be reduced. Since noises resulting from floating nodes are low frequency noises, the noises resulting from floating nodes can be reduced by driving the plurality of first signal lines so that polarities of the first linear sum signals are inverted.

A touch panel controller (capacitance distribution detection circuit 2c) in accordance with third aspect of the present invention is a touch panel controller which calculates distribution of capacitances of a plurality of capacitors provided at respective intersections where a plurality of first signal lines and a plurality of second signal lines intersect with each other, the plurality of first signal lines being capacitive-coupled with first floating nodes via first parasitic capacitors, respectively, and the plurality of second signal lines being capacitive-coupled with second floating nodes via second parasitic capacitors, respectively, the touch panel controller having calibration mode in which no touch input to any of the plurality of capacitors is made and a scan mode in which a touch input to at least one of the plurality of capacitors is detected, the touch panel controller including: a driving section (driver 5c) for (i) driving, at a calibration mode first timing, the plurality of first signal lines in accordance with a code sequence so that the plurality of second signal lines output calibration mode first linear sum signals based on electric charges of the plurality of capacitors, respectively, and (ii) driving, at a calibration mode second timing, the plurality of second signal lines in accordance with the code sequence so that the plurality of first signal lines output calibration mode second linear sum signals based on electric charges of the plurality of capacitors, respectively; an amplifier for (i) amplifying, at the calibration mode first timing, the calibration mode first linear sum signals respectively outputted from the plurality of second signal lines and (ii) amplifying, at the calibration mode second timing, the calibration mode second linear sum signals respectively outputted from the plurality of first signal lines; and a capacitance distribution calculation section for calculating a calibration mode capacitance distribution in accordance with the calibration mode first linear sum signals, the calibration mode second linear sum signals, and the code sequence, the driving section driving, at a scan mode first timing, the plurality of first signal lines in accordance with the code sequence so that the plurality of second signal lines output scan mode first linear sum signals based on electric charges of the plurality of capacitors, respectively, and driving, at a scan mode second timing, the plurality of second signal lines in accordance with the code sequence so that the plurality of first signal lines output scan mode second linear sum signals based on electric charges of the plurality of capacitors, respectively, the amplifier amplifying, at the scan mode first timing, the scan mode first linear sum signals respectively outputted from the plurality of second signal lines, and amplifying, at the scan mode second timing, the scan mode second linear sum signals respectively outputted from the plurality of first signal lines, the capacitance distribution calculation section calculating a scan mode capacitance distribution in accordance with the scan mode first linear sum signals, the scan mode second linear sum signals, and the code sequence, and calculating the distribution of capacitances of the plurality of capacitors by subtracting the calibration mode capacitance distribution from the scan mode capacitance distribution, and operation timing in the calibration mode being equal to operation timing in the scan mode.

With the above arrangement, noises having the same pattern every time are mixed into the signals from the first floating nodes and the second floating nodes. By making the operation timing in the calibration mode and the operation timing in the scan mode equal to each other, it is possible to cancel and eliminate noises mixed in the calibration mode and noises mixed in the scan mode by subtracting the calibration mode capacitance distribution from the scan mode capacitance distribution.

The touch panel controller in accordance with fourth aspect of the present invention may be arranged, in the arrangement of the third aspect, such that the operation timing includes the number of a frame to be added in frame driving in accordance with the code sequence, the order of driving in accordance with the code sequence, and a sampling frequency of the calibration mode first and second linear sum signals and a sampling frequency of the scanning mode first and second linear sum signals.

The above arrangement enables the operation timing in the calibration mode and the operation timing in the scan mode to be equal to each other. Consequently, it is possible to cancel and eliminate noises mixed in the calibration mode and noises mixed in the scan mode by subtracting the calibration mode capacitance distribution from the scan mode capacitance distribution.

A touch panel controller (capacitance distribution detection circuit 2d) in accordance with fifth aspect of the present invention is a touch panel controller which calculates distribution of capacitances of a plurality of capacitors provided at respective intersections where a plurality of first signal lines and a plurality of second signal lines intersect with each other, the touch panel controller including: a driving section (driver 5d) for driving, at a first timing, the plurality of first signal lines in accordance with a code sequence so that the plurality of second signal lines output first linear sum signals based on electric charges of the plurality of capacitors, respectively; and an amplifier for amplifying, at the first timing, the first linear sum signals respectively outputted from the plurality of second signal lines, the driving section driving, at a second timing, the plurality of second signal lines in accordance with the code sequence so that the plurality of first signal lines output second linear sum signals based on electric charges of the plurality of capacitors, respectively, the amplifier amplifying, at the second timing, the second linear sum signals respectively outputted from the plurality of first signal lines, the second timing being a time after voltages of floating nodes have been stabilized, the floating nodes being capacitive-coupled with the plurality of first signal lines via parasitic capacitors, respectively.

With the above arrangement, at the second timing after voltages of floating nodes capacitive-coupled with the plurality of first signal lines via parasitic capacitors, respectively, have been stabilized, the plurality of second signal lines are driven in accordance with the code sequence, and the second linear sum signals based on electric charges of the capacitors are outputted from the plurality of first signal lines, respectively. Consequently, the plurality of second signal lines are driven after noises resulting from floating nodes capacitive-coupled with the plurality of first signal lines via parasitic capacitors, respectively, have been reduced. Accordingly, it is possible to reduce the influence of the noises on driving of the plurality of second signal lines.

A touch panel controller in accordance with sixth aspect of the present invention is preferably arranged, in any one of the second, third, and fifth aspects of the present invention, such that the amplifier is a differential amplifier corresponding to adjacent ones of the plurality of first signal lines and adjacent ones of the plurality of second signal lines.

With the above arrangement, noise resistance can be further increased by differential amplification.

A touch panel system in accordance with seventh aspect of the present invention includes a touch panel controller in accordance with any one of the first through third and fifth aspects of the present invention.

An electronic device (mobile phone 90) in accordance with eighth aspect of the present invention includes the touch panel system in accordance with the seventh aspect of the present invention.

The present invention is not limited to the description of the embodiments above, but may be altered by a skilled person within the scope of the claims. An embodiment based on a proper combination of technical means disclosed in different embodiments is encompassed in the technical scope of the present invention. Furthermore, a new technical feature can be made by combining technical means disclosed in individual embodiments.

### Industrial Applicability

The present invention is applicable to (i) a touch panel controller which calculates distribution of capacitances of a plurality of capacitors provided at respective intersections where a plurality of first signal lines and a plurality of second signal lines intersect with each other, (ii) a touch panel system using the touch panel controller, and (iii) an electronic device using the touch panel controller.

### Reference Signs List

1a-1d Touch panel system

2a-2d Capacitance distribution detection circuit (touch panel controller)

5a-5d Driver

6 Sense amplifier (amplifier)

9, 9c, 9d Capacitance distribution calculation section

90 Mobile phone (electronic device)

HL1-HLN Signal lines (first signal lines)

VL1-VLM Signal lines (second signal lines)

CP Parasitic capacitor (first parasitic capacitor, second parasitic capacitor)

Float1, Float2 Floating node (first floating node, second floating node)

1-6. (canceled)

7. A touch panel controller which calculates distribution of capacitances of a plurality of capacitors provided at respective intersections where a plurality of first signal lines and a plurality of second signal lines intersect with each other,
the plurality of first signal lines being capacitive-coupled with first floating nodes via first parasitic capacitors, respectively, and the plurality of second signal lines being capacitive-coupled with second floating nodes via second parasitic capacitors, respectively,
the touch panel controller comprising:
a driving section for driving, at a first timing, the plurality of first signal lines with a same driving voltage so that the plurality of second signal lines output first linear sum signals based on electric charges of the plurality of capacitors, respectively; and
an amplifier for amplifying, at the first timing, the first linear sum signals respectively outputted from the plurality of second signal lines,
the driving section driving, at a second timing which is a driving timing subsequent to the first timing, the plurality of second signal lines in accordance with a code sequence so that the plurality of first signal lines output second linear sum signals based on electric charges of the plurality of capacitors, respectively,
the amplifier amplifying, at the second timing, the second linear sum signals respectively outputted from the plurality of first signal lines,
the amplifier being a differential amplifier corresponding to adjacent ones of the plurality of first signal lines and adjacent ones of the plurality of second signal lines,
the touch panel controller further comprising a capacitance distribution calculation section for calculating the distribution of capacitances of the plurality of capacitors in accordance with the second linear sum signals and the code sequence,
at the second timing at which the plurality of second signal lines are driven in accordance with the code sequence, corresponding two ones of the first floating nodes outputting voltage signals that change similarly, the corresponding two first floating nodes being capacitive-coupled with corresponding two adjacent ones of the plurality of first signal lines, the corresponding two adjacent first signal lines being connected with the differential amplifier.

8. A touch panel controller which calculates distribution of capacitances of a plurality of capacitors provided at respective intersections where a plurality of first signal lines and a plurality of second signal lines intersect with each other,
the touch panel controller comprising:
a driving section for driving, at a first timing, the plurality of first signal lines in accordance with a code sequence so that the plurality of second signal lines output first linear sum signals based on electric charges of the plurality of capacitors, respectively; and
an amplifier for amplifying, at the first timing, the first linear sum signals respectively outputted from the plurality of second signal lines,
the driving section driving, at a second timing, the plurality of second signal lines in accordance with the code sequence so that the plurality of first signal lines output second linear sum signals based on electric charges of the plurality of capacitors, respectively,
the amplifier amplifying, at the second timing, the second linear sum signals respectively outputted from the plurality of first signal lines,
the plurality of second signal lines being capacitive-coupled with floating nodes via parasitic capacitors, respectively, and
the driving section driving the plurality of first signal lines so that polarities of the first linear sum signals are inverted in time sequence and a noise resulting from at least one of the floating nodes is subdued.

9. A touch panel controller which calculates distribution of capacitances of a plurality of capacitors formed at intersections of a plurality of first signal lines and a plurality of second signal lines,
the plurality of first signal lines being capacitive-coupled with first floating nodes via first parasitic capacitors, respectively, and the plurality of second signal lines being capacitive-coupled with second floating nodes via second parasitic capacitors, respectively,
the touch panel controller having a calibration mode in which no touch input to any of the plurality of capacitors is made and a scan mode in which a touch input to at least one of the plurality of capacitors is detected,
the touch panel controller comprising:
a driving section for (i) driving, at a calibration mode first timing, the plurality of first signal lines in accordance with a code sequence so that the plurality of second signal lines output calibration mode first linear sum signals based on electric charges of the plurality of capacitors, respectively, and (ii) driving, at a calibration mode second timing, the plurality of second signal lines in accordance with the code sequence so that the plurality of first signal lines output calibration mode second linear sum signals based on electric charges of the plurality of capacitors, respectively;
an amplifier for (i) amplifying, at the calibration mode first timing, the calibration mode first linear sum signals respectively outputted from the plurality of second signal lines and (ii) amplifying, at the calibration mode second timing, the calibration mode second linear sum signals respectively outputted from the plurality of first signal lines; and
a capacitance distribution calculation section for calculating a calibration mode capacitance distribution in accordance with the calibration mode first linear sum signals, the calibration mode second linear sum signals, and the code sequence,
the driving section driving, at a scan mode first timing, the plurality of first signal lines in accordance with the code sequence so that the plurality of second signal lines output scan mode first linear sum signals based on electric charges of the plurality of capacitors, respectively, and driving, at a scan mode second timing, the plurality of second signal lines in accordance with the code sequence so that the plurality of first signal lines output scan mode second linear sum signals based on electric charges of the plurality of capacitors, respectively,
the amplifier amplifying, at the scan mode first timing, the scan mode first linear sum signals respectively outputted from the plurality of second signal lines, and amplifying, at the scan mode second timing, the scan mode second linear sum signals respectively outputted from the plurality of first signal lines,
the capacitance distribution calculation section calculating a scan mode capacitance distribution in accordance with the scan mode first linear sum signals, the scan mode second linear sum signals, and the code sequence, and calculating the distribution of capacitances of the plurality of capacitors by subtracting the calibration mode capacitance distribution from the scan mode capacitance distribution,
operation timing in the calibration mode being equal to operation timing in the scan mode, and
the number of repeating frames for calculating a true capacitance, corresponding to a frame addition number in the calibration mode and a frame addition number in the scan mode, wherein the frame addition number in the calibration mode is equal to the frame addition number in the scan mode.

10. The touch panel controller as set forth in claim 8, wherein the amplifier is a differential amplifier corresponding to adjacent ones of the plurality of first signal lines and adjacent ones of the plurality of second signal lines.

11. The touch panel controller as set forth in claim 9, wherein the amplifier is a differential amplifier corresponding to adjacent ones of the plurality of first signal lines and adjacent ones of the plurality of second signal lines.

12. An electronic device, comprising a touch panel system including a touch panel controller as set forth in claim 7.

13. An electronic device, comprising a touch panel system including a touch panel controller as set forth in claim 8.

14. An electronic device, comprising a touch panel system including a touch panel controller as set forth in claim 9.
